(19) United States
(12) Patent Application Publication
(10) Pub. No.: US 2025/0209415 A1
(43) Pub. Date: Jun. 26, 2025

(54) METHODS AND APPARATUS TO COORDINATE RETURNS USING QR CODES

(71) Applicant: Returned.com, Inc., Boulder, CO (US)

(72) Inventors: Patrick A. Justis, Longmont, CO (US); Paul Pao-Yen Lin, Boulder, CO (US)

(21) Appl. No.: 18/903,697

(22) Filed: Oct. 1, 2024

Related U.S. Application Data
(60) Provisional application No. 63/645,669, filed on May 10, 2024.
(60) Provisional application No. 63/613,724, filed on Dec. 21, 2023.
(60) Provisional application No. 63/614,407, filed on Dec. 22, 2023.

(51) Int. Cl. G06Q 10/0837; G06K 7/14; G06Q 10/0833

(52) U.S. Cl. CPC G06Q 10/0837; G06K 7/1417; G06Q 10/0833

(57) ABSTRACT

Systems, apparatus, articles of manufacture, and methods are disclosed to coordinate returns using Quick Response (QR) codes. An example non-transitory machine-readable storage medium includes instructions to cause programmable circuitry to at least: access a request based on a scan of a QR code, the request including an identifier of the QR code; determine whether the identifier is associated with an item for delivery; after a determination that the identifier is not associated with the item, cause display of a first user interface for association of the identifier with first transit information corresponding to the item; and after a determination that the item is associated with the first transit information, cause display of a second user interface to present second transit information corresponding to the item.

### RELATED APPLICATIONS

This patent claims the benefit of U.S. Provisional Patent Application No. 63/645,669, which was filed on May 10, 2024, U.S. Provisional Patent Application No. 63/613,724, which was filed on Dec. 21, 2023, and U.S. Provisional Patent Application No. 63/614,407, which was filed on Dec. 22, 2023. U.S. Provisional Patent Application No. 63/645,669, U.S. Provisional Patent Application No. 63/613,724, and U.S. Provisional Patent Application No. 63/614,407 are hereby incorporated herein by reference in its entirety. Priority to U.S. Provisional Patent Application No. 63/645,669, U.S. Provisional Patent Application No. 63/613,724, and U.S. Provisional Patent Application No. 63/614,407 are hereby claimed.

### FIELD OF THE DISCLOSURE

This disclosure relates generally to returned item logistics and, more particularly, to methods and apparatus to coordinate returns using quick response (QR) codes.

### BACKGROUND

In recent years, increases in commercialism and digital advertising have led to a rise in consumer purchasing. In many examples, a consumer may purchase a product that they then decide to return. A consumer may return a product for any reason, including but not limited to the product arriving as damaged, the product not matching a corresponding description, the consumer finding an alternative product with lower cost and/or better performance, and/or more generally, the consumer no longer wanting or needing the originally purchased product.

### BRIEF DESCRIPTION OF THE DRAWINGS

FIG. 1 is a block diagram of an example environment in which an example product is returned using a QR code.

FIG. 2 is an illustrative example of QR codes and transit packages that may be utilized in the example environment of FIG. 1.

FIG. 3 is an illustrative example of a client device executing the application of FIG. 1.

FIG. 4 is a block diagram of an example implementation of the return coordinator circuitry of FIG. 1.

FIG. 5 is a flowchart representative of example machine-readable instructions and/or example operations that may be executed, instantiated, and/or performed by example programmable circuitry to implement a client device of FIG. 3.

FIG. 6 is a flowchart representative of example machine-readable instructions and/or example operations that may be executed, instantiated, and/or performed by the return coordinator circuitry of FIG. 4 before a return is initiated.

FIG. 7 is a flowchart representative of example machine-readable instructions and/or example operations that may be executed, instantiated, and/or performed by the return coordinator circuitry of FIG. 4 when a return is initiated.

FIG. 8 is a flowchart representative of example machine-readable instructions and/or example operations that may be executed, instantiated, and/or performed by the return coordinator circuitry of FIG. 1 to determine a destination for a product as described in FIG. 7.

FIG. 9 is a flowchart representative of example machine-readable instructions and/or example operations that may be executed, instantiated, and/or performed by the return coordinator circuitry of FIG. 1 to determine a transit plan for a product as described in FIG. 7.

FIG. 10 is a flowchart representative of example machine-readable instructions and/or example operations that may be executed, instantiated, and/or performed by the return coordinator circuitry of FIG. 1 to respond to a request to access the URL linked to a QR code as described in FIG. 7.

FIGS. 11A, 11B, 11C, 11D, 11E, and 11F are illustrative examples of information that may be displayed in response to a request to access a URL as described in FIG. 10.

FIG. 12 is an illustrative example of providing delivery facing transit information as described in FIG. 10.

FIG. 13 is a flowchart representative of example machine-readable instructions and/or example operations that may be executed, instantiated, and/or performed by the return coordinator circuitry of FIG. 1 to provide delivery facing transit information as described in FIG. 10.

FIG. 14 is a block diagram of an example processing platform including programmable circuitry structured to execute, instantiate, and/or perform the example machine-readable instructions and/or perform the example operations of FIGS. 5-10 and 13 to implement the return coordinator circuitry 112 and/or client device 104 of FIGS. 3 and 4.

FIG. 15 is a block diagram of an example implementation of the programmable circuitry of FIG. 13.

FIG. 16 is a block diagram of another example implementation of the programmable circuitry of FIG. 13.

FIG. 17 is a block diagram of an example software/firmware/instructions distribution platform (e.g., one or more servers) to distribute software, instructions, and/or firmware (e.g., corresponding to the example machine-readable instructions of FIGS. 5-10 and 13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily scaled.

### DETAILED DESCRIPTION

A consumer may decide to return a product with any number of goals. For example, a consumer may want to a) remove the returned product from their home as quickly from possible, b) maximize a monetary compensation for the value of the returned product, and/or c) return the product with minimal effort. In some examples, a consumer may prioritize one or more of the foregoing goals over the others and/or have a different goal. However, logistical barriers may impede a consumer's ability to return a product in a manner that meets one or more of their goals. As used herein, a consumer may be additionally or alternatively referred to as a user.

As used herein, the term product is hereby defined as a good or a service. For example, a product may be a tangible product (e.g., a pair of shoes, a laptop computer, a food item). Alternatively, a product may be an intangible product (e.g., a digital asset, such as a non-fungible token (NFT), executable instructions, etc.). In some examples, a product may represent a subscription to a service (e.g., a continuously available service such as a television or media streaming service, a repeating service (e.g., a cleaning service), a one-time service, etc.). In some examples, a product may represent a right (e.g., a right to enter a venue, a right to play media, a right to use real estate, etc.). While the following examples are described in terms of return of a tangible product, such examples may be equally applicable to return of non-tangible products.

One factor that affects the user experience of returning a product is determining where the product should be sent. Some products are purchased using an e-commerce platform that offers products from a wide variety of sellers. In such examples, a consumer may use a first communication system to contact the e-commerce platform to determine where to return the product. In other examples, a user may digitally purchase a product directly from a seller. In such an example, each seller may have an independent communication system describing how to contact them and determine a location. Therefore, a user may be required to remember any number of different communication systems (e.g., which phone number to call, which application to open, which email to save, where a link is within an email, etc.) based on where the product is purchased. Maintaining information from such a diverse set of sources can add complexity to the return process and degrade the user experience.

In addition to engaging with various communication systems, engaging with various return policies can further complicate a user's ability to return a product. A business's decision to return a product may depend on any number of factors, including but not limited to the length of time since the original purchase, whether the product has been opened or used, the reason for the return, etc. As a result, some businesses may decide to accept a request to return a product while other businesses would not accept the same request to return the same product. If a business decides not to accept a returned product, the user may then have to decide whether to try selling the product themselves, recycling the product, donating the product, discarding the product, etc. Accordingly, while a user may have multiple options for where to send a returned product, identifying said options can be a difficult task. Furthermore, each return option that a user can identify may satisfy one or more of the goals of the return differently from other return options.

Once a user does select a return option, initiating the transit of the product away from an initial destination (e.g., their home) poses an additional logistical challenge. In some examples, the user buys postage, determines the mass of the product, and affixes an appropriate number of stamps. In some examples, the user prints a specific shipping label and securely tapes the shipping label to a package. The user may additionally need to determine whether: a) they should bring the package to a drop-off location or b) the product will be picked up by a delivery service. Such steps may require an amount of cost, time, and effort from the user, thereby reducing the user experience and frustrating the goals of the return.

Example methods, systems, and apparatus described herein enable the return of products in a manner that reduces complexity for any person involved in the initialization, transportation, and receipt of a returned product. A user describes the product to be returned using an example application. The user also scans a Quick Response (QR) code affixed to a transit package and places the product in the transit package. The example application communicates with example return coordinator circuitry, which associates return information with a webpage to which the QR code points. The example return server circuitry determines a final destination for the product based on a configurable prioritization scheme. The example return coordinator circuitry also determines a transit plan to transport the package to the final destination and initiates the transit plan. Any number of individuals along the transit plan (e.g., employees at delivery services, individuals at intermediate destinations or the final destination, etc.) may scan the QR code on the transit package. Accordingly, the return coordinator circuitry can cause display of different information on the corresponding webpage based on the transit status of the package.

More generally, example methods, systems, and apparatus described herein enable the delivery of items between any two destinations. In some examples, the delivery is a return as described above. In other examples, the product is associated with a QR code as described above but delivered from the possession of a first user to another destination (e.g., another consumer, a recycling center, donation center, etc.) In still other examples, the product is associated with a QR code as described above but delivered from a business (e.g., a manufacturer or retailer) to a user who purchased the product. In any of the foregoing examples, the association between the product and the QR code enables a user-initiated action (including but not limited to a return or a shipment) and the provision of information on a corresponding webpage based on transit status. The term “user-initiated action” may refer to an action initiated by any type of individual (e.g., a consumer, an employee of a retailer, manufacturer, or delivery service, etc.). Accordingly, the teachings of this disclosure can reduce complexity for any party associated with any type of delivery.

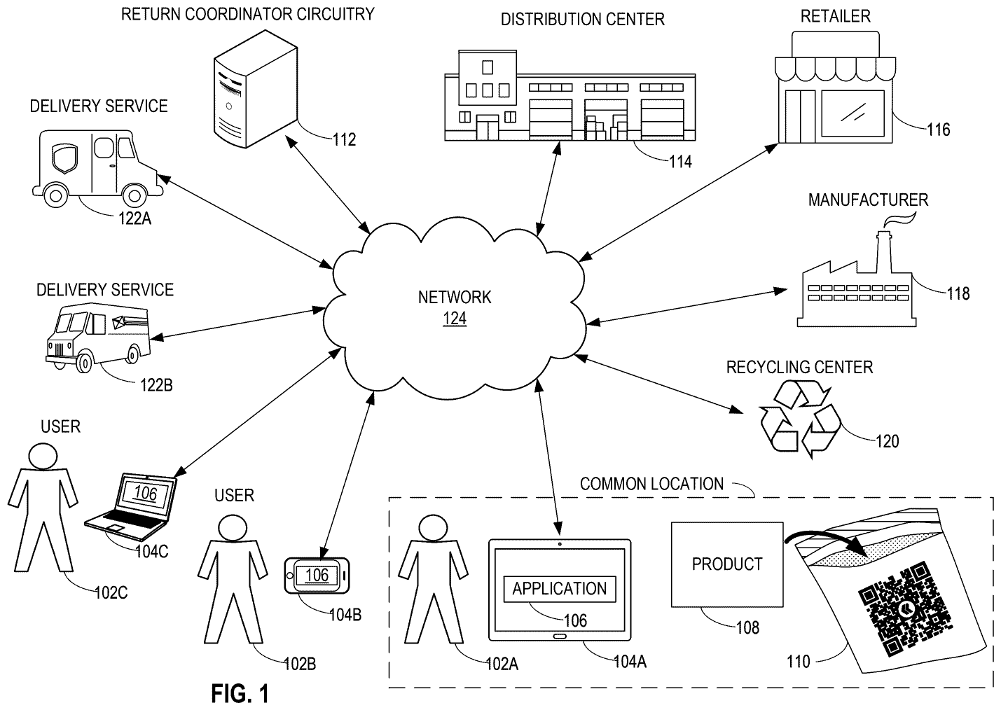

FIG. 1 is a block diagram of an example environment 100 in which an example product is returned using a QR code. FIG. 1 includes example users 102A, 102B, 102C (collectively referred to as users 102), example client devices 104A, 104B, 104C (collectively referred to as client devices 104), am example application 106, an example product 108, an example transit package 110, example return coordinator circuitry 112, an example distribution center 114, and example retailer 116, an example manufacturer 118, an example recycling center 120, example delivery services 122A, 122B (collectively referred to as delivery services 122), and an example network 124.

The example users 102 are individuals who have access to the application 106. In many examples, one or more users 102 possess a product they no longer wish to keep. A given user 102A may have any reason to not keep a product. The example users 102 may have any demographics, live at any location, and possess any number of products. While FIG. 1 refers to three users 102A, 102B, 102C for simplicity, the teachings of this disclosure may be applied to any number of users 102. Similarly, while examples described below may refer to the user 102A for simplicity, the teachings of this disclosure may apply to any of the users 102.

The example client devices 104 are electronic devices used by the users 102. That is, the user 102A uses the client device 104A, the user 102B uses the client device 104B, etc. The client devices 104 may be implemented by any device capable of accessing the network 124. For example, in the illustrated example of FIG. 1, the client device 104A is a tablet, the client device 104B is a smart phone, and the client device 104C is a laptop. In some examples, the client devices 104 may be referred to as end devices, nodes, edge devices, etc. The client devices 104 may include any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs).

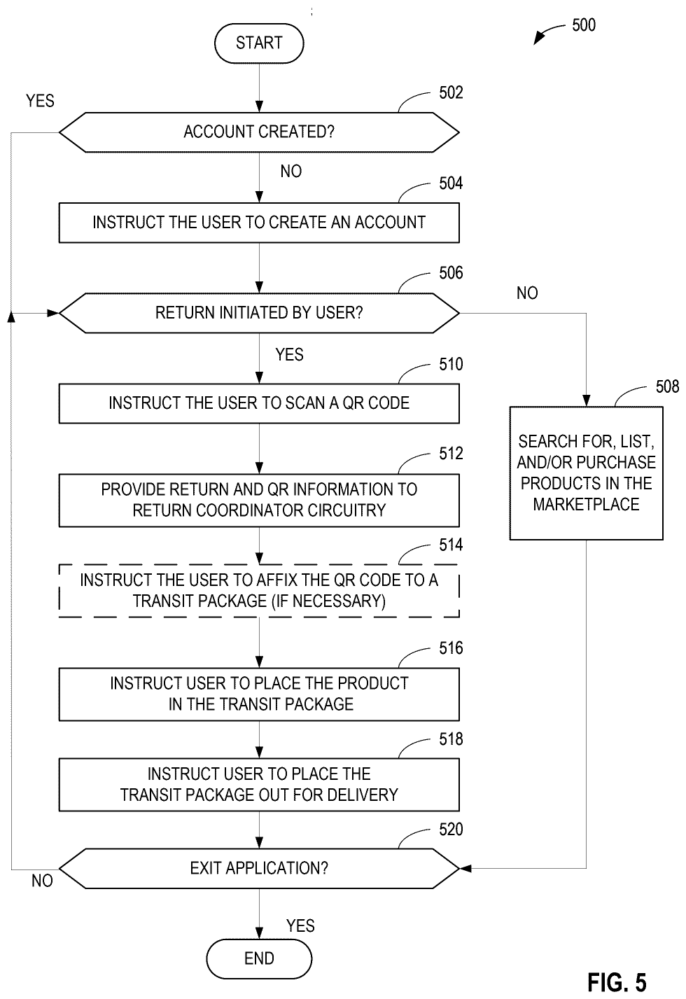

The example application 106 represents machine-readable instructions that may be executed or instantiated (e.g., creating an instance of, bring into being for any length of time, materialize, implement, etc.) by any type of programmable circuitry. In the example of FIG. 1, the application 106 is implemented by the client devices 104. Client devices 104 executing the application 106 communicate with the return coordinator circuitry 112 to enable transportation of products from possession of the users 102 to another destination. The application 106 is discussed further in connection with FIG. 5.

The example product 108 is an object in possession of the user 102A. In some examples, the product 108 is a product that the user 102A purchased online. The product 108 may be any size, shape, weight, have any function, etc. In examples described herein, the product 108 is a tangible object. In other examples, the product 108 is an intangible object as discussed above.

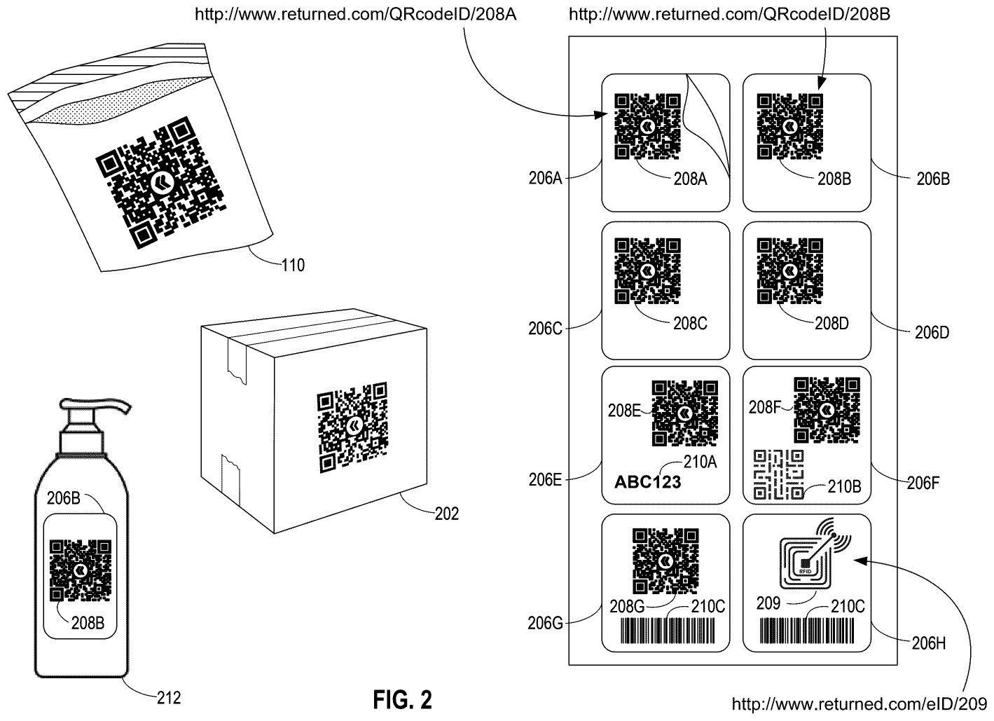

The example transit package 110 is a container used to protect the product 108 during transit. The transit package 110 includes a QR code on at least one external surface. Accordingly, the QR code is visible when the transit package 110 is closed. In contrast, some or all of the product 108 may be obstructed from visual inspection when the transit package 110 is closed. The transit package 110 is discussed further in connection with FIG. 2.

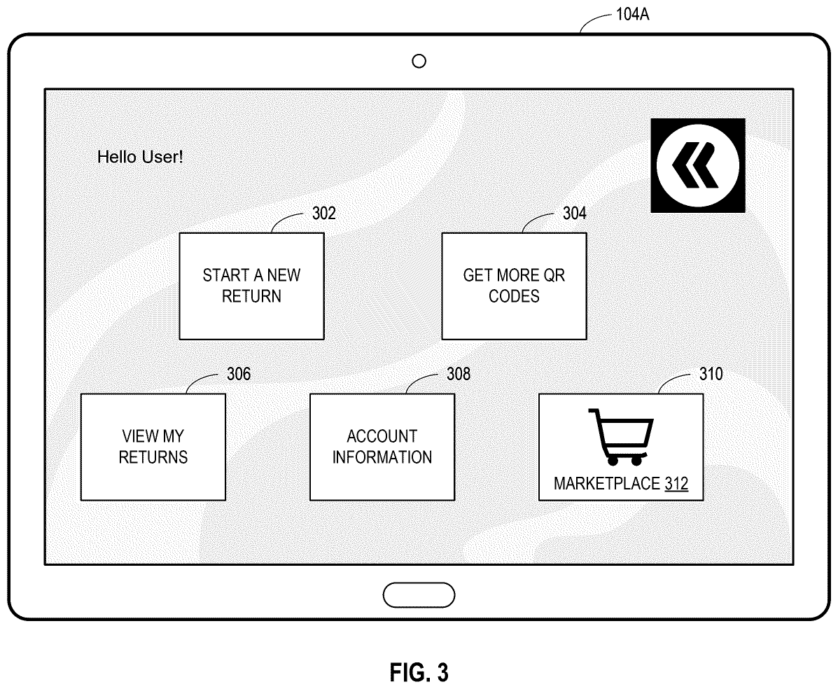

The example return coordinator circuitry 112 communicates with the application 106 and hosts webpages to enable transportation of products from the possession of the users 102 to another destination. In some examples, the return coordinator circuitry 112 facilitates a return by transporting the product 108 back to the business that originally sold the product 108 to the user. The return coordinator circuitry 112 may be implemented using any number of compute resources, including any type of programmable circuitry. In some examples, the return coordinator circuitry 112 may be referred to as a server, a back end, a main frame, etc. The return coordinator circuitry 112 is discussed further in combination with FIG. 3.

The example distribution center 114 is a facility that receives, sorts, organizes, labels, and/or ships packages based on instructions from the return coordinator circuitry 112. That is, the distribution center 114 may act as an intermediate destination that stores the product 108 for an amount of time before distributing the product 108 to a final destination. In some examples, the return coordinator circuitry 112 and distribution center 114 are managed by a common organization (e.g., returned.com). Such an organization may include any number of distribution centers located in any number of locations. In examples herein, a “managing organization” may refer to any such entity or organization that manages the return coordinator circuitry 112, the distribution center 114, and/or, more generally, the transportation of the product 108 between destinations.

The example retailer 116 refers to a business where the user 102A purchased the product 108. In some examples, the retailer 116 includes one more physical (AKA “brick-and-mortar”) stores. The retailer 116 may additionally or alternatively communicate with the user 102A digitally. The retailer 116 may have any number of policies describing which products can be returned, when a product can be returned, the monetary value a consumer receives for returning a product, etc.

The example manufacturer 118 refers to a business that produced (e.g., created, built, manufactured, assembled, etc.) the product 108. The manufacturer 118 may have any number of policies describing which products can be returned, when a product can be returned, the monetary value a consumer receives for returning a product, etc.

The example recycling center 120 refers to an organization that accepts products for re-use and/or recycling. The recycling center 120 may have any number of policies describing which materials are accepted, the types of products that can and cannot be broken down into composite materials, etc.

The delivery services 122 refer to any service that transports products between locations. For example, the delivery service 122A is a private shipping company and the delivery service 122B is a postal service. The delivery services 122 may also refer to ride share services, individual contractors within the gig economy, etc. Accordingly, the delivery services 122 may have any number of policies describing where products can be picked up from, where products can be delivered to, mass limits, price and timing options, etc.

The network 124 of FIG. 1 connects and facilitates communication between the various entities illustrated in FIG. 1. In this example, the network 124 is the Internet. However, the example network 124 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

After identifying the product 108 for return, the user 102A places the product 108 in the transit package and initiates a return using a local copy of the application 106 (via the client device 104A). The client device 104A, while executing the application 106 describes the product 108 and/or the user 102A to the return coordinator circuitry 112 via the network 124.

The user 102A also uses the client device 104A to scan the QR code on the transit package 110. The QR code points to one of the webpages hosted by the return coordinator circuitry 112. In some examples, the QR code corresponds to a uniform resource link (URL) that includes an identification value used to distinguish the return coordinator webpages from one another. Accordingly, the application 106 causes the client device 104A to report the identification value to the return coordinator circuitry 112 via the network 124. The return coordinator circuitry 112 then associates the product 108 information and/or the user 102 information with webpage that corresponds to the identification value.

The URL that corresponds to the QR code may be formatted according to any suitable webpage communication protocol. For example, the URL may include headers including but not limited to HyperText Transfer Protocol (http), HTTP Secure (https), World Wide Web (www), etc. The URL may additionally include fields that provide parameters based on the corresponding communication protocol. Such parameters include but are not limited to the identification value discussed above.

Once a return is initiated by the user 102A via the application 106 and the client device 104A, the return coordinator circuitry 112 determines a final destination to transport the product 108 to. The final destination may be the location of the retailer 116, the manufacturer 118, the recycling center 120, or any other location. In some examples, the return coordinator circuitry 112 determines the final destination is the location of another user 102B who has agreed to purchase the product 108 from the user 102A. As used above and herein, a “return” may refer to any transportation of a product from an initial destination to a final destination, regardless of whether the product is a product and regardless of whether the final destination is an organization that produced and/or sold the product. The return coordinator circuitry 112 also determines one or more intermediate destinations for the product (e.g., the distribution center 114, a post office, etc.) to enable the transportation between the initial and final destinations. The return coordinator circuitry 112 also schedules one or more delivery services 122 to transport the product 108 between the destinations.

Advantageously, the user 102A does not have to write any transit information or print and tape any shipping labels to the transit package. Accordingly, in some examples, the transit package 110 may travel between destinations with the QR code as the only markings on its surface. Any number of individuals may scan the QR code as the transit package 110 travels between destinations. Therefore, the return coordinator circuitry 112 provides a visual interface generated when a device requests access to the webpage with the identification value. The visual interface may provide information to enable the individuals to transport the product 108 to the appropriate destination. In some examples, the visual interface may be referred to as a user interface.

Individuals that scan the QR code may serve any number of roles. For example, an individual scanning the QR code may be the user 102A, an employee or representative of a delivery service, intermediate destination, or a final destination, a stranger finding a lost package, etc. Advantageously, the return coordinator circuitry 112 alters the contents of the webpage associated with the product to present content/information based on the individual scanning the website, characteristics of the product 108, and/or the transit status of the product 108.

FIG. 2 is an illustrative example of QR codes and transit packages that may be utilized in the example environment of FIG. 1. FIG. 2 includes the example transit package 110 of FIG. 1, an example transit package 202, example stickers 206A, 206B, 206C, 206D, 206E, 206F, 206G, and 206H (collectively referred to as stickers 206), and an example product 212. The stickers 206 include example QR codes 208A, 208B, 208C, 208D, 208E, 208F, and 208G (collectively referred to as QR codes 208). The stickers 206E-206H also include example markings 210A, 210B, 210C (collectively referred to as markings 210), and the sticker 206H includes an electronic identification tag 209. The electronic identification tag may be implemented using a Radio Frequency Identification (RFID) tag. In some examples, a sticker may include both a QR code (or other visual identification information) in addition to the electronic identification tag. In this manner, any number of visual identification markings and/or electronic identification tags may be included in and/or with a sticker.

The user 102A may place products in any type and any size of transit package for protection during shipping. In FIG. 1, the user 102A places the product 108 in the transit package 110, which may be implemented as a poly-mailer or any other type of polybag. In other examples, user 102 may place products in the transit package 202, which is a cardboard box. In yet other examples, a transit package may be implemented as a different type of container and/or composed out of a different material.

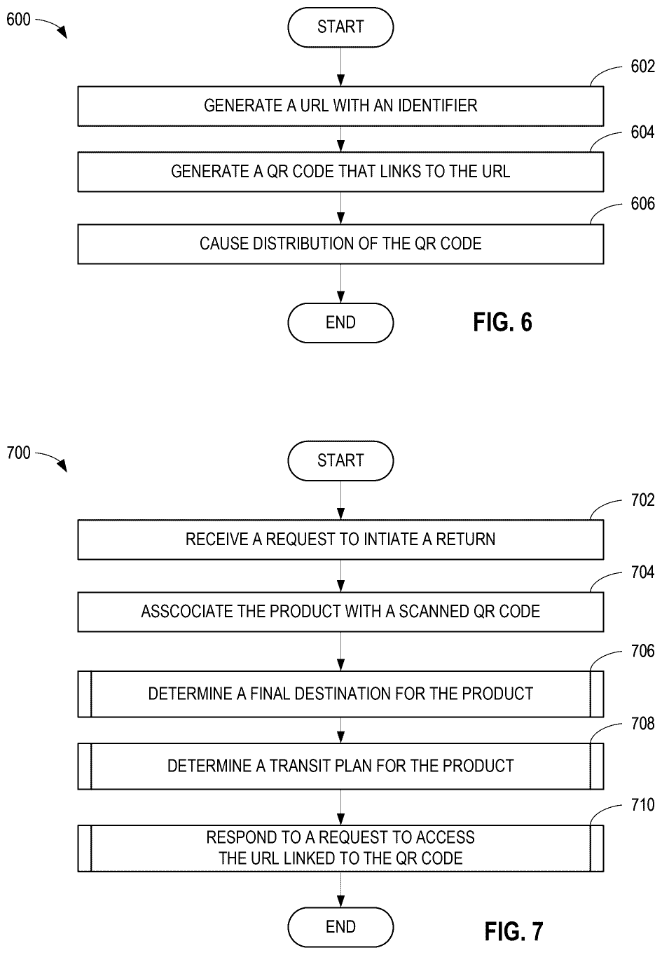

In some examples, the QR code is pre-affixed to a transit package (e.g., printed directly onto the material of the package with ink, printed on paper and taped to the package, etc.) before the user 102A obtains the transit package. In other examples, the users 102 apply one of the stickers 206 to a transit package without markings. The users 102 may obtain the stickers 206 from any location (e.g., at local businesses, by ordering sheets of stickers through the application 106, in the package that came when the product 108 was originally purchased and shipped, etc.). Distribution of QR codes is discussed further in connection with FIG. 6.

Regardless of distribution method, QR codes distributed by the managing organization point to one of the webpages hosted by the return coordinator circuitry 112. In some examples, the QR codes 208 may be considered unique because the return coordinator circuitry 112 associates information from one return per webpage. In the example of FIG. 2, the QR code 208A points to a URL that ends in ‘/208A’, while the QR code 208B points to a URL that ends in ‘/208B’. Accordingly, the QR codes 208A and 208B point to two different webpages and may be used simultaneously to coordinate the return of two different products.

In some examples, one or more markings 210 may be printed on the stickers 206 in addition to the corresponding QR codes 208. For example, the marking 210A is an alphanumeric code on the sticker 206E, the marking 210B is a second QR code on the sticker 206G, and the marking 210C is a bar code on the stickers 206G and 206H. The additional markings 210 may be used to describe transit information for a particular delivery service 122 to a particular destination. For example, the marking 210C may be interpretable (e.g., scanned) by the delivery service 122B and cause the transit package to be mailed to the distribution center 114. As an additional example, the marking 210B may cause the delivery service 122A to transport the transit package to a third-party distribution center. After determining destinations and delivery services 122 to be used for a particular turn, the return coordinator circuitry 112 may instruct a user 102B (via the network 124 and the application 106) to apply a particular sticker based on what markings 210 (if any) are required to support the transportation.

In some examples, a sticker may include an electronic identification (eID) tag 209 in addition to or in place of a QR code. In general, the eID tag 209 includes electronic components (e.g., a small IC and an antenna). In some examples, these electronic components do not require continuous power to operate. Rather, when a device capable of reading eID tags (e.g., the client device 104B, a device operated by the delivery service 122A, 122B, etc.) scans the eID tag 209, the reading device emits electromagnetic waves. The tag then uses the energy within the electromagnetic waves to transmit data back to the reading device.

In examples disclosed herein, electronic tags that are managed by the managing organization operate similarly to QR codes managed by the managing organization. For example, the eID tag 209 causes the client device 104B to access a unique URL (e.g., a URL that ends in ‘/209’ as shown in FIG. 2). Like the QR codes 208, the URL from the eID tag 209 points to a unique webpage that may be used to coordinate the return of a product. In some examples, the URL of the eID tag 209 may be the same as the URL used by the accompanying QR code. In some other examples, a different URL may be utilized to enable distinction of whether the eID tag 209 or the QR code 208 was used.

In examples disclosed herein, radio frequency identification (RFID) is used to implement the eID tag 209. However, other electronic identification technology or technologies may additionally or alternatively be used such as, for example, near-field communication (NFC), Bluetooth Low Energy (BLE), etc.

RFID uses radio waves to transmit data between a reader and an RFID tag attached to an object. The tags can be active, passive, or semi-passive depending on their power source. RFID tags are typically operable within a wide physical range including, for example, when the reader device is directly adjacent to the RFID tag (e.g., within a few millimeters), to a few feet or meters away from the RFID tag. Such an operational distance is useful when attempting to scan or identify a tag at a distance (e.g., to identify a package on the floor or a counter while a user operating the reader device is standing nearby). In some examples, multiple RFID tags may be identifiable at once.

Alternatively, NFC is a short-range wireless connectivity technology that enables communication between devices when they are brought close to each other (e.g., less than 4 cm). NFC is often used for contactless payments, data exchange between devices, and access control in smartphones and Internet of Things (IoT) applications. In some examples, using NFC at close range may reduce the likelihood that a sticker is mis-identified when compared to RFID (which has a longer range capable of identifying multiple stickers and thus may be ambiguous). Therefore, the operational range of an electronic identification technology may be useful in selecting which technology or technologies to implement.

In some examples, multiple different electronic identification technologies may be used together. For example, an NFC tag within the sticker 208 may enable a user to use their mobile device (e.g., a smartphone) to scan a tag at close range, enabling precise identification of the tag; whereas a transit entity (e.g., a shipping company, the delivery service 122A, 122B) may utilize an RFID tag within the sticker 208 to enable identification of multiple packages at a longer range (e.g., for shipping and/or logistics purposes).

As noted above, any number of individuals along the transit plan (or even outside of the transit plan), may utilize an electronic identification tag reader (e.g., an RFID reader) to scan and/or otherwise identify the package to which an electronic identification tag is affixed.

In some examples, such scanning may be performed in bulk, enabling multiple transit packages to be identified at once. Such bulk identification may be useful during the transit process to, for example, update the location and/or status of a transit package. For example, scanning a truckload of packages at once may enable a courier to update the location of those packages.

In some examples, the scanning is performed using a mobile scanner (e.g., a handheld RFID scanner, such as a scanner implemented within the user device 106). However, in some other examples, a statically-located scanner is used to enable an identification of when a transit package was near a particular physical location. For example, a loading dock may include one or more RFID scanners that enable the scanning of transit packages (e.g., multiple transit packages) without human intervention. In some examples, a physical identifier (e.g., a QR code, a barcode, etc.) might not be visible. In such an example, the use of an electronic identification tag facilitates identification of a transit package without the need for visual identification. Moreover, the scanning of an electronic identification tag may further enable a determination of whether a transit package is in an incorrect location (e.g., has been loaded onto a truck that is not destined for a same location as the transit package), enabling transit errors to be identified and remedied without delay.

In any event, when scanning the electronic identification tag, the courier may perform a lookup of the identifier that was read from the electronic identification tag. Such a lookup enables the courier to translate the electronic identification of the transit package into a tracking identifier used by the courier. Such a lookup may be performed by communicating with the return coordinator circuitry 112. In some other examples, identification information may be provided to the courier to enable the courier to perform a lookup within a tracking system of the courier itself.

In the example of FIG. 2, the user 102B applies the sticker 206B directly to the product 212 (e.g., a shampoo bottle). More generally, any user may apply a sticker containing a QR code to any type of product. The return coordinator circuitry 112 may in turn cause transportation of the product without also transporting a transit package. In some examples, such transportation may be referred to as “boxless” shipping.

The return coordinator circuitry 112 and/or the user 102B may determine a product should be delivered without a transit package for any number of reasons, including but not limited to the availability of transit packages to the user 102B, the durability of the product 212, etc. In the example of FIG. 2, the user 102B decides to apply the sticker 206B directly to the product 212 and reports the same within the application 106 (via the client device 104B). In such examples, the return coordinator circuitry 112 may determine a final destination and/or a transit plan based in part on the fact that the product 212 is travelling without a transit package and therefore may be more susceptible to damage.

FIG. 3 is an illustrative example of the client device executing the application 106 of FIG. 1. In particular, FIG. 3 illustrates a visual interface that may be presented on the client device 104A when executing machine-readable instructions that include the application 106. The visual interface includes example buttons 302, 304, 306, 308, and 310. The button 310 corresponds to an example marketplace 312.

The example button 302 enables a user to start a new return. After pressing the button 302, the application 106 may update the visual interface to prompt the user 102A to enter a description of the product 108, enter information describing themselves, and scan the QR code on the transit package 110. In some examples, the user 102A grants the application 106 and/or the return coordinator circuitry 112 access to purchases and orders made by the user 102A. The user 102A may grant such access through any number of avenues, including but not limited to providing access to an email inbox, signing into an e-commerce website, etc. In such examples, pressing the button 302 may cause the application 106 to update the visual interface with a list of recent orders. The user 102A may then select one order and scan a QR code to initiate a return of a product in the order.

The example button 304 enables the user 102A to obtain additional QR codes. For example, pressing the button 304 may cause the application 106 to inform the return coordinator circuitry 112 of the button press, and for the return coordinator circuitry 112 to cause the shipment of a sheet of stickers 206 to the user 102A. Additionally or alternatively, pressing the button 304 causes the application 106 to update the visual interface to present a list of locations and/or names of businesses near the user 102A. The user 102A can then visit any of the locations to obtain an additional sheet of stickers 206 and/or pick up transit packages with pre-affixed QR codes.

The example button 306 enables the user 102A to view their returns. For example, pressing the button 304 may cause the application 106 to update the visual interface to present a list of products that the user has requested a return for. The visual interface may also include the status of the return (e.g., canceled, in progress, or completed), tracking information for returns that are in progress, a description of the returned product, an amount of money obtained for exchange of the returned product, and/or, more generally, any suitable information the user 102A desires in order to monitor past and/or present returns.

The example button 308 enables the user 102A to view and/or edit their account information. For example, pressing the button 304 may cause the application 106 to update the visual interface to present various information describing the user 102A for viewing and/or editing. Such account information may include but is not limited to the user's name, date of birth, email address, postal address, payment information, etc. In some examples, the user 102A may also view and/or edit preferences using the button 308. User preferences may include but are not limited to whether they will drop products off at third party destinations or should have all products picked up from their mail address, the range of third-party destinations they will visit if they do choose to drop products off (e.g., locations less than x miles from their mail address), instructions for delivery services to pick products up from their mail address (e.g., on a porch, behind a screen door, use a particular code to open the front door), etc.

The example button 310 enables the user 102A to enter the marketplace 312. The marketplace 312 refers to a virtual market where users 102 can buy and sell products from one another. In some examples, users 102 may enter the marketplace 312 to post a product, negotiate price with potential buyers, and select another user to receive the product once a final agreement is made. In other examples, users 102 do not communicate directly with one another on the marketplace 312. Rather, the return coordinator circuitry 112 connects sellers to prospective buyers based on both party's preferences and activity within the marketplace 312. In some examples, the return coordinator circuitry 112 coordinates: a) the purchase of a product from user 102A, and b) the independent sale of the product to a different user 102B, using the marketplace 312. The return coordinator circuitry 112 also coordinates the delivery of any product that moves destinations due to a sale in the marketplace 312.

The application 106 serves as a single, accessible communication system for the user 102A to initiate the return/delivery of products. Accordingly, the application 106 reduces complexity for the user 102A and provides a streamlined alternative to users manually navigating varying communication systems and policies to initiate returns on a product-by-product basis.

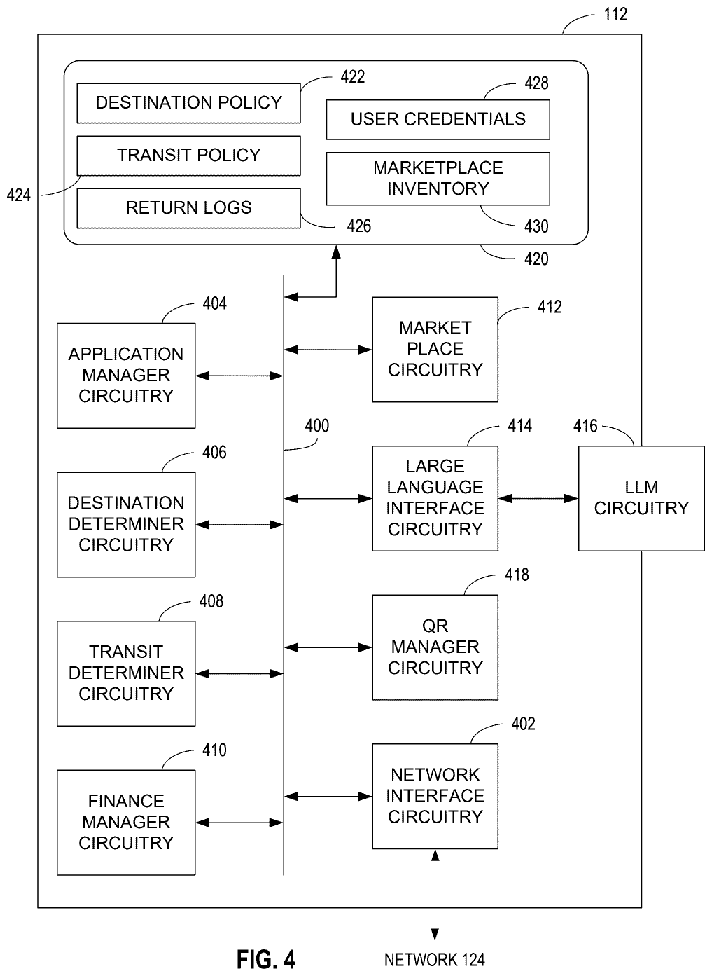

FIG. 4 is a block diagram of an example implementation of the return coordinator circuitry 112 of FIG. 1. The return coordinator circuitry 112 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the return coordinator circuitry 112 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The return coordinator circuitry 112 of FIG. 4 includes an example bus 400, example network interface circuitry 402, example application manager circuitry 404, example destination determiner circuitry 406, example transit determiner circuitry 408, example finance manager circuitry 410, example marketplace circuitry 412, example large language interface circuitry 414, example large language model (LLM) circuitry 416, example QR manager circuitry 418, and example memory 420. The memory 420 includes an example destination policy 422, an example transit policy 424, example return logs 426, example user credentials 428, and example marketplace inventory 430.

The example bus 400 refers to one or more physical connections (e.g., an interconnect, copper trace, etc.) that enables communication between the example network interface circuitry 402, the application manager circuitry 404, the destination determiner circuitry 406, the transit determiner circuitry 408, the finance manager circuitry 410, example marketplace circuitry 412, the large language interface circuitry 414, the large language model (LLM) circuitry 416, the QR manager circuitry 418, and the memory 420. The bus 400 may be implemented using one or more communication systems that meet pre-determined threshold power and latency requirements.

The example network interface circuitry 402 enables the exchange of data between other components of the application manager circuitry 404 and external entities (e.g., local copies of the application 106 via the client devices 104, the distribution center 114, the retailer 116, the manufacturer 118, the recycling center 120, the delivery services 122, etc.) via the network 124. The network interface circuitry 402 may transmit and/or receive any type of data, including but not limited to application programming interface (API) requests, API responses, emails, interactions with third-party webpages, chat-bot messages, etc. The network interface circuitry 402 may include transceivers, antennas, and/or other hardware components required to send and receive Internet data. The network interface circuitry 402 may implement a wired and/or wireless connection to the network 124. In some examples, the network interface circuitry 402 is instantiated by programmable circuitry executing network interface instructions and/or configured to perform operations such as those represented by the flowchart(s) of FIGS. 5-10 and 13.

The application manager circuitry 404 provides instructions to, and performs operations based on, client devices 104 executing the application 106. For example, when the client device 104A executing the application 106 provides a description of the product 108 and informs the return coordinator circuitry 112 of a request to initiate a return, the network interface circuitry 402 forwards the information to the application manager circuitry 404 via the bus 400. In response, the application manager circuitry 404 may perform one or more of: a) informing the QR manager circuitry 418 of the identification value in the URL provided by the application 106 and affixed to the transit package 110, b) causing the destination determiner circuitry 406 to determine a final destination for the product, and/or c) storing the description of the product 108 and/or the account information of the user 102A in appropriate portions of the memory 420.

In some examples, the application manager circuitry 404 additionally or alternatively informs the client devices 104 (via the network interface circuitry 402 and the network 124) of updates to the application 106. Updates to the application 106 may occur for any reason, including but not limited to software bugs, changes in prioritization schemes or policies, etc. In some examples, the application manager circuitry 404 is instantiated by programmable circuitry executing application manager instructions and/or configured to perform operations such as those represented by the flowchart(s) of FIGS. 5-10 and 13.

The example destination determiner circuitry 406 determines a final destination for a returned product based on instructions from the application manager circuitry 404. To determine the final destination, the destination determiner circuitry 406 may optionally communicate with one or more prospective final destinations to select an option based on information about the user 102A, the product 108, the prospective destinations, and/or a configurable prioritization scheme. In some examples, the destination determiner circuitry 406 is instantiated by programmable circuitry executing destination determiner instructions and/or configured to perform operations such as those represented by the flowchart(s) of FIGS. 5-10 and 13.

The example transit determiner circuitry 408 receives a final destination from the destination determiner circuitry 406 via the bus 400. The transit determiner circuitry 408 then determines a transit plan to enable the transportation of the corresponding product (e.g., product 108) from its current location to the final destination. The transit plan may include the identification of one or more intermediate destinations and one or more delivery services 122 to move the product 108 between destinations. In some examples, the transit determiner circuitry 408 is instantiated by programmable circuitry executing transit determiner instructions and/or configured to perform operations such as those represented by the flowchart(s) of FIGS. 5-10 and 13.

The example finance manager circuitry 410 coordinates the exchange of money between a destination and the user 102A for the value of the returned product. For example, if the retailer 116 or the manufacturer 118 receives the product 108 and determines a refund can be made, a final party (e.g., an employee or other type of representative associated with the final destination) can provide a dollar amount and banking information to finance manager circuitry 410 via a visual interface that enables the final party to digitally communicate with the return coordinator circuitry 112. The finance manager circuitry 410 may initiate an Electronic Funds Transfer (EFT) to move the money from the final destination's account to a financial account associated with the user 102A. In some examples, the finance manager circuitry 410 also coordinates the exchange of funds into and out of a bank associated with the managing organization. Such a bank account may be used to buy and sell products from users 102 via the marketplace, temporarily hold refunds of a returned product 108, etc. In some examples, the finance manager circuitry 410 is instantiated by programmable circuitry executing finance manager instructions and/or configured to perform operations such as those represented by the flowchart(s) of FIGS. 5-10 and 13.

The marketplace circuitry 412 manages the marketplace 312 accessible to users 102 through the application 106. For example, the marketplace circuitry 412 may enable and/or moderate virtual chat rooms where users 102 can negotiate with one another for the price of a product 108. Additionally or alternatively, the marketplace circuitry 412 may decide whether to buy or sell products on behalf of the managing organization based on pre-determined policies. The marketplace circuitry 412 may also determine, through coordination with the application manager circuitry 404, what information is shown on a visual interface when a user 102A enters the marketplace 312 by pressing button 310 of FIG. 3. In some examples, the marketplace circuitry 412 is instantiated by programmable circuitry executing marketplace instructions and/or configured to perform operations such as those represented by the flowchart(s) of FIGS. 5-10 and 13.

In some examples, the example large language interface circuitry 414 of the illustrated example of FIG. 4 receives instructions, from the destination determiner circuitry 406 to generate a prompt that enables communication with a destination that may receive the product 108. The large language interface circuitry 414 and provides the prompt to the LLM circuitry 416. In some examples, the large language interface circuitry 414 receives a prompt directly from the destination determiner circuitry 406. The example large language interface circuitry 414 receives a response from the LLM circuitry 416 including a response message. In some examples, when communicating with the LLM circuitry 416, the example large language interface circuitry 414 identifies a model that is to be used by the LLM circuitry 416 to process the prompt. In some examples, the large language interface circuitry 414 is instantiated by programmable circuitry executing large language interface instructions and/or configured to perform operations such as those represented by the flowchart(s) of FIGS. 5-10 and 13.

The example LLM circuitry 416 of the illustrated example of FIG. 4 executes a large language model to transform an input prompt into an output message. In the illustrated example of FIG. 4, the example LLM circuitry 416 may execute a selected model at the direction of the large language interface circuitry 414. For example, a first model may be utilized if the large language interface circuitry 414 is attempting to communicate with a destination via email, as a human representative at a destination is likely reading the email. In such examples, the output message from the LLM circuitry 416, which the destination determiner circuitry 406 uses to compose the body of the email, may require increased emphasis on tone, grammar, and human readability. In contrast, the LLM circuitry 416 may utilize a second model if the large language interface circuitry 414 is attempting to communicate with a destination via a chat-bot. In such a second example, the output message from the LLM circuitry 416, which the destination determiner circuitry 406 uses to compose the body of the chat messages, may require the inclusion of specific terms and/or less emphasis on human readability because a human is unlikely to be reading the chat. In some examples, the LLM circuitry 416 is instantiated by programmable circuitry executing LLM instructions and/or configured to perform operations such as those represented by the flowchart(s) of FIGS. 5-10 and 13.

A large language model (LLM) operates by utilizing a neural network architecture known as a Transformer. LLMs are designed to understand and generate human-like text based on the vast amount of data on which the LLM has been trained. In the illustrated example of FIG. 4, the LLM circuitry 416 is illustrated at the edge of the return coordinator circuitry 112 to represent that the LLM circuitry 416 may be executed/implemented either locally to the return coordinator circuitry 112 or at a computing system remote from the return coordinator circuitry 112. For example, large language models may be executed in a cloud setting (e.g., remotely from the return coordinator circuitry 112). Remote execution offers some advantages including, for example, that the LLM can be accessed from anywhere, providing scalability and ease of use. Cloud-based models are usually more powerful than locally executed models, as cloud-based models typically leverage high-performance hardware and are continuously updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity with more control over their data, and potentially lower latency for inference. Local execution can also work offline, which is beneficial in scenarios with limited Internet access or where data privacy is important. However, local execution typically requires powerful hardware, significant storage, and regular updates to maintain model performance.

The QR manager circuitry 418 performs operations based on requests to access the webpages hosted by the return coordinator circuitry 112 and associated with QR codes. For example, when the application manager circuitry 404 provides an identification value of a URL and reports that a return has been initiated, the QR manager circuitry 418 associates the corresponding product 108 information and/or user 102A information with the identification value in memory 420. Furthermore, the QR manager circuitry 418 determines what information should be provided when a request to access the webpage with said identification value is received, regardless of when the request is received. Advantageously, the QR manager circuitry 418 may change the information provided to a request to access the webpage based on any number of factors, including but not limited to status of the transit package 110 (e.g., its current location, the current responsible delivery service, an estimated amount of time until the transit package 110 reaches the final destination, etc.) In some examples, the QR manager circuitry 418 is instantiated by programmable circuitry executing QR manager instructions and/or configured to perform operations such as those represented by the flowchart(s) of FIGS. 5-10 and 13.

The memory 420 is implemented by any memory, storage device and/or storage disc for storing data such as, for example, flash memory, magnetic media, optical media, solid state memory, hard drive(s), thumb drive(s), etc. Furthermore, the data stored in the memory 420 may be in any data format such as, for example, binary data, comma delimited data, tab delimited data, structured query language (SQL) structures, etc. While, in the illustrated example, the memory 420 is illustrated as a single device, the memory 420 and/or any other data storage devices described herein may be implemented by any number and/or type(s) of memories.

Within the memory 420, the example destination policy 422 describes configuration parameters used by the destination determiner circuitry 406 when determining a final destination for a product 108. The destination determiner circuitry 406 may use one or more configuration parameters from the destination policy 422 to: determine which locations to consider as final destinations for a given product, communicate with the large language interface circuitry 414 and LLM circuitry 416 (e.g., do or do not include certain words, limit output messages to certain word or character limits, etc.), and/or prioritize one location over another when selecting a final destination.

Within the memory 420, the example transit policy 424 describes configuration parameters used by the transit determiner circuitry 408 when determining a transit plan from an initial location of the product 108 to the final destination. The transit policy 424 may include information including but not limited to: the locations of various intermediate destinations, a list of potential delivery services and their respective policies (e.g., regions of operations, mass limits), etc.

Within the memory 420, the example return logs 426 describe information related to the returns (e.g., the transportation of a product from one destination to another) that are completed, canceled, in progress, and/or scheduled by the return coordinator circuitry 112. For example, the application manager circuitry 404 stores information describing the user 102A, the product 108A, and a return identification value together in the return log 426. The QR manager circuitry 418 also stores the identification value of the URL from the transit package 110 in association with the foregoing information within the return log 426.

In some examples, once the return of the product 108 is completed, the QR manager circuitry 418 may re-associate the identification value of the URL to a different set of return information in the return log 426. In doing so, the return coordinator circuitry 112 may re-use a finite number of webpages while still employing one webpage per active return (e.g., a return that is in-progress). Similarly, the QR manager circuitry 418 may disassociate the identification value of the URL with the return information of product 108 for any reason (e.g., the return is complete, a threshold amount of time has passed, etc.). In doing so, the QR manager circuitry 418 prevents information regarding the product 108 to be provided when the webpage is accessed, thereby limiting the exposure of potentially sensitive information to external parties.

Within the memory 420, the example user credentials 428 stores information that the return coordinator circuitry 112 utilizes to communicate with the users 102. Examples of data stored in the user credentials 428 include but are not limited to usernames, passwords, email addresses, mail addresses, user preferences, financial information, etc. The user credentials 428 may be stored within memory 420 using any suitable encryption technique to ensure data privacy.

Within the memory 420, the example marketplace inventory 430 stores a description of products available for purchase on the marketplace 312. The marketplace circuitry 412 and/or application manager circuitry 404 may access and/or edit the marketplace inventory 430 based on inputs from the users 102 via the client devices 104 and the application 106. Similarly, the marketplace circuitry 412 and/or application manager circuitry 404 may use the marketplace inventory 430 to determine what content should populate visual interface when the user 102A presses button 310 in FIG. 3.

While an example manner of implementing the return coordinator circuitry 112 and/or client device 104 of FIG. 1 is illustrated in FIGS. 3 and 4, one or more of the elements, processes, and/or devices illustrated in FIGS. 3 and 4 may be combined, divided, re-arranged, omitted, eliminated, and/or implemented in any other way. Further, the example network interface circuitry 402, the application manager circuitry 404, the destination determiner circuitry 406, the transit determiner circuitry 408, the finance manager circuitry 410, example marketplace circuitry 412, the large language interface circuitry 414, the LLM circuitry 416, the QR manager circuitry 418, the memory 420, and/or, more generally, the example return coordinator circuitry 112 and/or client device 104 of FIGS. 3 and 4, may be implemented by hardware alone or by hardware in combination with software and/or firmware. Thus, for example, any of the example network interface circuitry 402, the application manager circuitry 404, the destination determiner circuitry 406, the transit determiner circuitry 408, the finance manager circuitry 410, example marketplace circuitry 412, the large language interface circuitry 414, the LLM circuitry 416, the QR manager circuitry 418, the memory 420, and/or, more generally, the example return coordinator circuitry 112 and/or client device 104, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example return coordinator circuitry 112 and/or client device 104 of FIGS. 3 and 4 may include one or more elements, processes, and/or devices in addition to, or instead of, those illustrated in FIGS. 3 and 4, and/or may include more than one of any or all of the illustrated elements, processes, and devices.

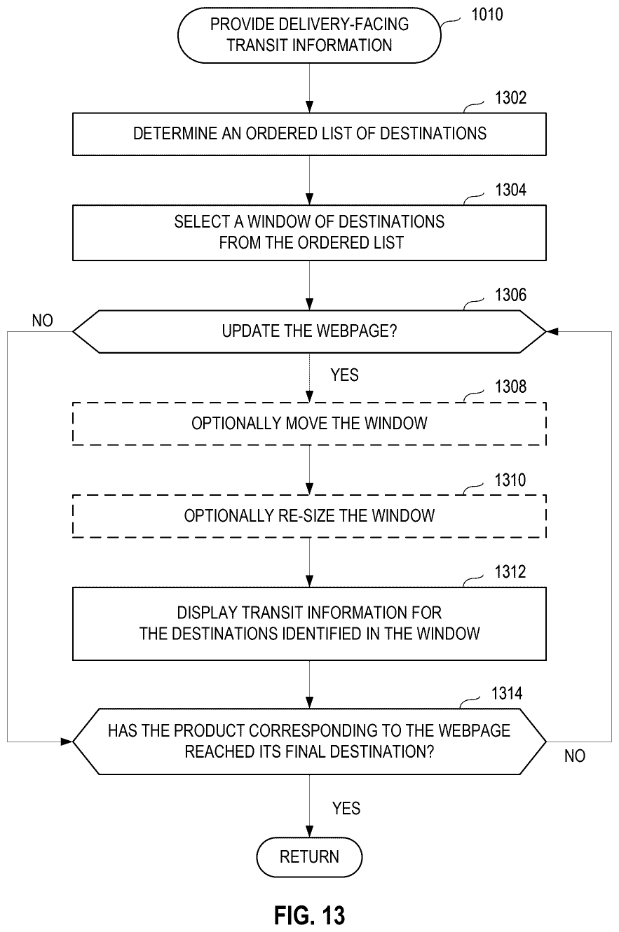

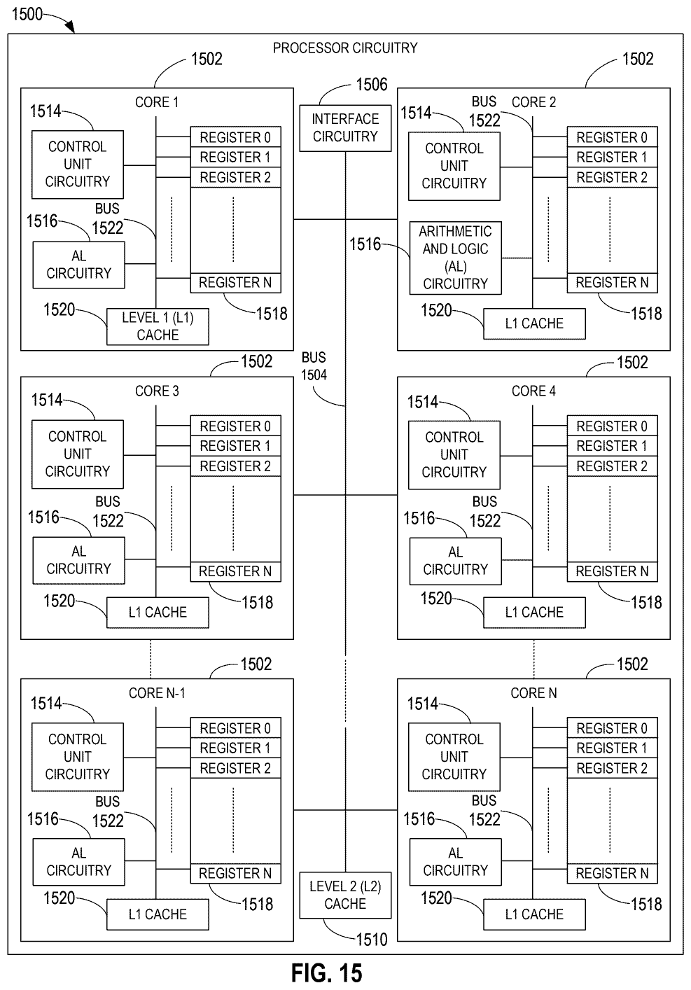

Flowchart(s) representative of example machine-readable instructions, which may be executed by programmable circuitry to implement and/or instantiate the return coordinator circuitry 112 and/or client device 104 of FIGS. 3 and 4 and/or representative of example operations which may be performed by programmable circuitry to implement and/or instantiate the return coordinator circuitry 112 and/or client device 104 of FIGS. 3 and 4, are shown in FIGS. 5-10 and 13. The machine-readable instructions may be one or more executable programs or portion(s) of one or more executable programs for execution by programmable circuitry such as the programmable circuitry 1412 shown in the example programmable circuitry platform 1400 discussed below in connection with FIG. 13 and/or may be one or more function(s) or portion(s) of functions to be performed by the example programmable circuitry (e.g., an FPGA) discussed below in connection with FIGS. 15 and/or 16. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-10 and 13, many other methods of implementing the example return coordinator circuitry 112 and/or client device 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C Sharp, Perl, Python, JavaScript, HyperText Markup Language (HTML), Structured Query Language (SQL), Swift, etc.

As mentioned above, the example operations of FIGS. 5-10 and 13 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by programmable circuitry to implement a client device 104 of FIG. 1. In particular, the flowchart of FIG. 5 describes operations that may be performed by a client device 104A while executing a local copy of the application 106. In some examples, one or more blocks of the flowchart of FIG. 5 may be implemented as machine-readable instructions that collectively refer to some or all of the application 106. Furthermore, while examples described below may refer to the user 102A, client device 104A, and product 108, the example flowcharts of FIGS. 5-10 and 13 may be applied to any of the users 102, client devices 104, and any product in accordance with the teachings of this disclosure.

The example machine-readable instructions and/or the example operations 500 of FIG. 5 begin when a user 102A first opens the application 106 on the client device 104A. At such point, the application 106 causes the client device 104A to determine if an account has been created. (Block 502). To do so, the application 106 may cause the client device 104A to: a) check local memory for the existence of user credentials, and b) transmit user credentials that are found locally to the return coordinator circuitry 112 for comparison against data in the user credentials 428. If an account has been created (Block 502: Yes), control proceeds to block 506. An account may be created if there are local user credentials that match a set of credentials stored remotely in the memory 420.

Alternatively, if an account has not been created (Block 502: No), the application 106 causes the client device 104A to instruct the user 102A to create an account. (Block 504). The creation of an account may include the user 102A providing one or more of a name, email address, mail address, financial information, etc.

After the user 102A creates an account following the prompt of block 504, or if an account was already created (Block 502: Yes), the application 106 causes the client device 104A to check if the user has initiated a return. (Block 506). To do so, the application 106 causes the client device 104A to check if button 302 was pressed and if relevant information describing the product 108 was subsequently provided.

If the user 102A has not initiated a return (Block 506: No), the application 106 enables the user 102A to search for, list, and/or purchase products in the marketplace 312. (Block 508). For example, the application 106 causes the client device 104A to report a selection of button 310 to the return coordinator circuitry 112 via the network 124, thereby prompting the application manager circuitry 404 and the marketplace circuitry 412 to determine what content should populate the visual interface of the client device 104A. Additionally or alternatively at block 508, the application 106 may cause the client device 104A to update a visual interface describing how to obtain additional QR codes, return history, and/or account information, based on whether buttons 304, 306, and 308 were pressed respectively.

If the user 102A has initiated a return (Block 506: Yes), the application 106 causes the client device 104A to instruct the user to scan a QR code. (Block 510). For example, the visual update of the client device 104A may update with instructions to scan one of the QR codes 208 (e.g., from one of the stickers) or to scan one of the QR codes pre-affixed to a transit package that has been distributed by the managing organization. In some examples, instructions displayed at block 510 cause the user 102A to scan a QR code from a particular sticker (e.g., sticker 206E) that does or does not have additional markings 210. The subsequent scan of the QR code by the user enables the application 106 to obtain an identification value of the corresponding URL.

The application 106 causes the client device 104A to provide return information and QR code information (e.g., the information obtained in connection with blocks 506 and 510) to the return coordinator circuitry 112. (Block 512). In some examples, the application 106 also causes the client device 104A to provide information describing the user 102A at block 512.

After providing the information of block 512, the application 106 receives, via the client device 104A, information from the return coordinator circuitry 112 describing a final destination and a transit plan. Accordingly, the application 106 causes the client device 104A to provide instructions that enable the user 102A to perform tasks that complete their portion of the return. Such instructions may include but are not limited to instructions to affix the QR code to a transit package if necessary. (Block 514). For example, if the user 102A scanned a QR code from a sticker at block 510, the user 102A applies the sticker to a transit package that did not have a pre-affixed QR code. In some examples, the instructions that enable the user 102A to complete the return instruct the user to affix the QR code (e.g., a sticker on which the QR code is printed) directly to the product (as discussed above in connection with FIG. 2).

The application 106 may cause the client device 104A to additionally instruct the user 102A to place the product 108 in the transit package 110 (Block 516) and to place the transit package 110 out for delivery (Block 518). In some examples, the application 106 causes the client device 104A to instruct the user 102A to bring the transit package to a drop-off location at block 518.

After the client device 104A has provided instructions to the user 102A (e.g., after block 518), or after the client device 104A has responded to a selection of one of buttons 304, 306, 308, and 310 (e.g., after block 508), the client device 104A checks if the user has exited the application 106. (Block 520). The user 102A may exit the application 106 by entering a system-level interface of the client device 104A, pressing an exit button, or otherwise closing the application 106.

If the user 102A has not exited the application 106 (Block 520: No), control returns to block 506 where the application 106 causes the client device 104A to check if the user 102A has initiated another return. If the user 102A has exited the application 106, the example machine-readable instructions and/or example operations 500 end.

FIG. 6 is a flowchart representative of example machine-readable instructions and/or example operations that may be executed, instantiated, and/or performed by the return coordinator circuitry 112 of FIG. 1 before a return is initiated. The example machine-readable instructions and/or the example operations 600 of FIG. 6 begin when the QR manager circuitry 418 of FIG. 4 generates a URL with an identifier value. (Block 602). The URL is associated with a webpage hosted by the return coordinator circuitry 112. In some examples, the return coordinator circuitry 112 hosts a finite number of webpages and re-uses webpages once returns are completed, as discussed above. In such examples, the QR manager circuitry 418 may disassociate a pre-existing URL and identifier with information of a completed return at block 602 rather than generating a new URL.

The QR manager circuitry 418 generates a QR code that links to the URL. (Block 604). The QR code may be any type, size, and/or resolution. In some examples, the QR code may include a visual component such as the logo of the managing organization (e.g., returned.com). In examples where the QR manager circuitry 418 identifies and associates a pre-existing URL at block 602, the QR manager circuitry 418 may similarly identify a pre-existing QR code at block 604 rather than generating a new one. The QR manager circuitry 418 may check the return logs 426 to ensure a QR code is not associated with an active return when performing the operations of block 604.

The QR manager circuitry 418 causes the distribution of the QR code. (Block 606). To cause distribution, the QR manager circuitry 418 may cause the QR code to be printed on a sticker or pre-affixed to a transit package. The QR manager circuitry 418 may then cause the QR code (via either a sheet of stickers or the transit package itself) to be shipped directly to the user. In some examples of block 606, the QR manager circuitry 418 causes the QR code to be provided to local businesses so that nearby users 102 can obtain the code. In other examples of block 606, the managing organization partners with one or more e-commerce entities and causes the QR code to be printed on a sticker and placed in the packaging of products that were recently purchased by the users 102 via an e-commerce platform. In yet other examples, the QR manager circuitry 418 coordinates with the application manager circuitry 404 to instruct a user, through the application 106 and client device 104A, to self-print the QR code at home. In some examples, the QR manager circuitry 418 distributes QR codes so that the certain characters within URL identification value correspond to a particular geographic region.

In still other examples, the QR manager circuitry 418 causes digital distribution of the QR code (e.g., being posted on a website, sent through an email, etc.) over the network 124. For example, the QR manager circuitry 418 may implement block 606 by sending instructions written in Zebra Program Language (ZPL) to a device via the network 124. ZPL refers to a markup language that describes the appearance of a printed page (generally labels). Of course, any other language that may describe the appearance of a printed page may additionally or alternatively be used. Accordingly, the device that receives the ZPL instructions may print the QR code of block 606 by executing the ZPL instructions. More generally, the QR manager circuitry 418 may use any computer programming language to digitally distribute the QR code. The example machine-readable instructions and/or operations 600 end after block 606.

In some examples, the QR code may be distributed to a retailer or other entity that is initially providing a product to a user. The retailer or other entity may obtain, for example, the QR code via an application programming interface (API) hosted and/or otherwise provided by the return coordinator circuitry 112. The QR code may, in such examples, be printed and then included in its printed form with the product (e.g., included in a package) when sending the product to a consumer. Inclusion of the QR code in the package facilitates more efficient returns of the product if the consumer decides to not keep the product. Advantageously, because the QR code is being included in the package, the QR code can be associated with information about the product, the consumer, the entity, etc.

FIG. 7 is a flowchart representative of example machine-readable instructions and/or example operations that may be executed, instantiated, and/or performed by the return coordinator circuitry 112 of FIG. 1 when a return is initiated. The example machine-readable instructions and/or example operations 700 begin when the application manager circuitry 404 receives a request to initiate a return. (Block 702). The return is initiated by the user 102A through a client device 104A executing a local copy of the application 106. Data corresponding to the return initialization is then provided to the application manager circuitry 404 via the network 124 and the network interface circuitry 402.

The example application manager circuitry 404 causes the QR manager circuitry 418 to associate the product 108 indicated in the return with a scanned QR code. (Block 704). To do so, the QR manager circuitry 418 associates the identifier value in the URL of the scanned QR code with the corresponding product 108 and/or user 102A information in the return logs 426. Associating values in the return logs 426 may refer to the inclusion of a pointer, and/or more generally, the use of any suitable technique to link two or more addresses together in the memory 420.

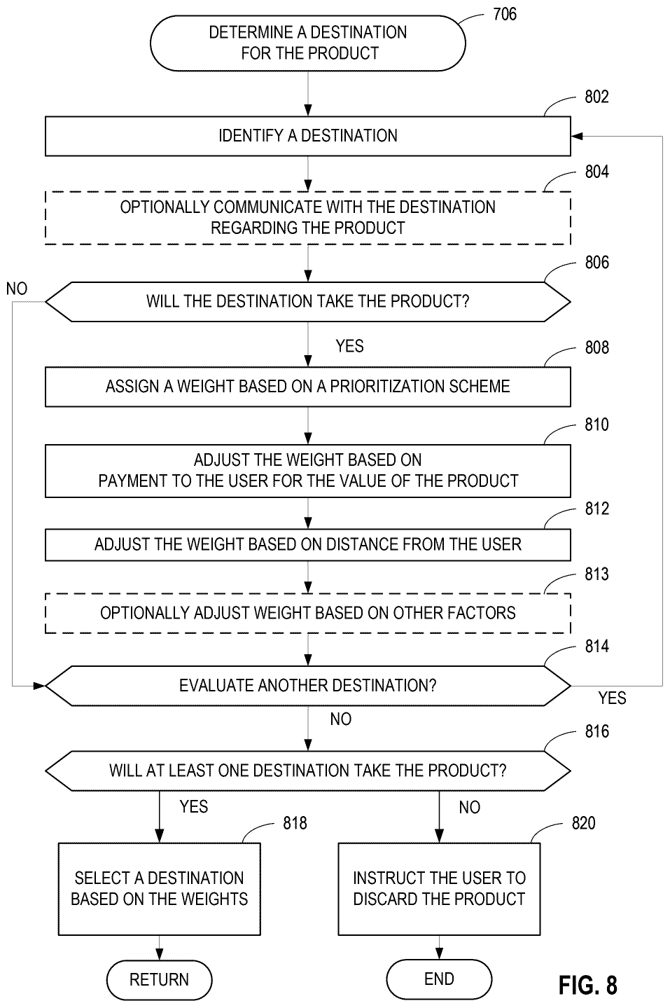

The example application manager circuitry 404 causes the destination determiner circuitry 406 to determine a final destination for the product. (Block 706). The destination determiner circuitry 406 may determine the destination based on information about the user 102A, the product 108, the prospective destinations, and/or a configurable prioritization scheme. Block 706 is discussed further in connection with FIG. 8.

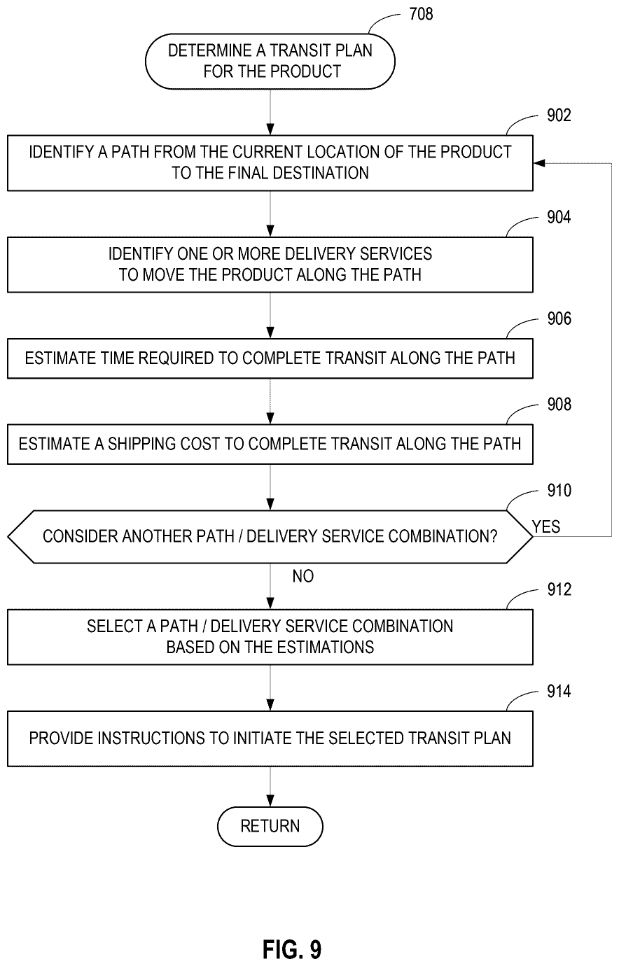

The example destination determiner circuitry 406 causes the transit determiner circuitry 408 to determine a transit plan for the product. (Block 708). As used above and herein, a transit plan refers to information that enables a product to travel from its current location to its final destination. A transit plan may include one or more intermediate destinations and one or more delivery services to transport the product 108 (within the transit package 110) between destinations. Block 708 is discussed further in connection with FIG. 9.

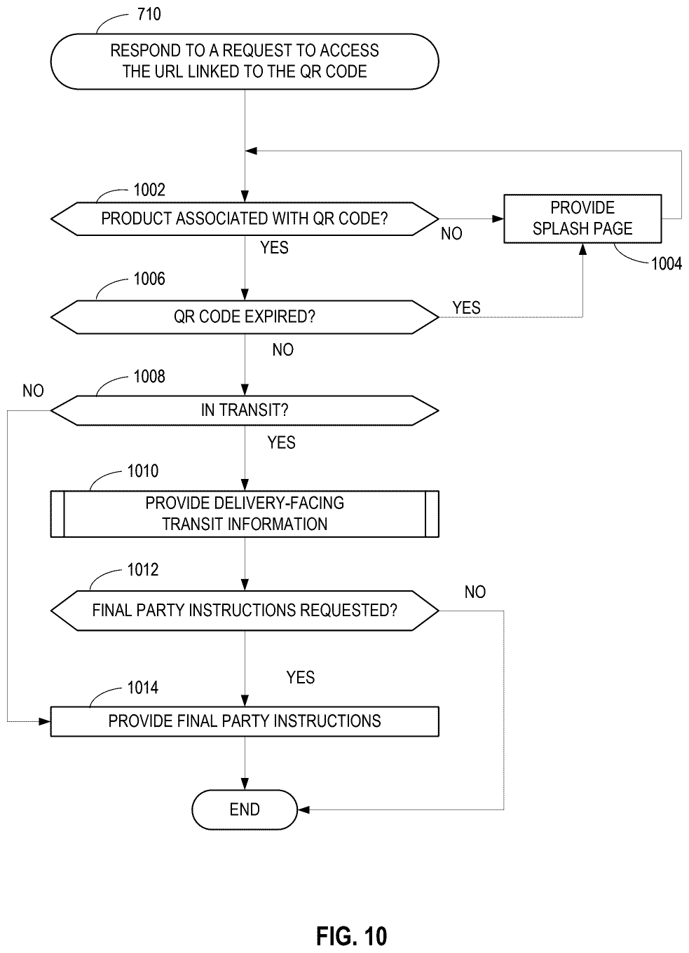

The example QR manager circuitry 418 responds to a request to access the URL linked to the QR code. (Block 710). The request may come from any device capable of connecting to the network 124 and performing an additional scan of the QR code. The request may also come at any time. As such, the request may be part of, or separate from, the transportation of the transit package 110 via the transit plan of block 708. Accordingly, the example QR manager circuitry 418 responds differently to requests to access the URL based on the available contextual information at the time (e.g., when the performance of block 710 is triggered by an external device). Block 710 is discussed further in connection with FIG. 10. The example machine-readable instructions and/or example operations 700 end after block 710.

FIG. 8 is a flowchart representative of example machine-readable instructions and/or example operations that may be executed, instantiated, and/or performed by the return coordinator circuitry of FIG. 1 to determine a destination for a product as described in FIG. 7. In particular, the flowchart of FIG. 8 is an example implementation of block 706 of FIG. 7.

Implementation of block 706 begins when the destination determiner circuitry 406 identifies a destination. (Block 802). The destination determiner circuitry 406 may identify any type of destination including, but not limited to, the retailer 116, the manufacturer 118, the recycling center 120, the location of one of the users 102, etc. The destination determiner circuitry 406 may identify multiple retailers, manufacturers, and/or recycling centers across multiple iterations of block 802.

The destinations at block 802 are candidates to be chosen as a final destination for the product 108. In some examples, the managing organization considers its distribution center 114 as only an intermediate destination. In such examples, the managing organization writes the destination policy 422 in memory 420 such that the destination determiner circuitry 406 does not identify the distribution center 114 at block 802. In other examples, the managing organization does consider the distribution center 114 a final destination (e.g., the managing organization may purchase a product from the seller via the marketplace 312 and store the product in the distribution center 114 for an unknown length of time until the product can be re-sold to a new buyer). In such other examples, the destination determiner circuitry may identify the distribution center 114 at block 802.

The example destination determiner circuitry 406 optionally communicates with the destination regarding the product. (Block 804). The destination determiner circuitry 406 may communicate with a given destination to determine whether the destination will accept the product. To do so, the destination determiner circuitry 406 may provide instructions to the large language interface circuitry 414 to cause the LLM circuitry 416 to produce human-like output messages that inquire whether the destination will take the device. The destination determiner circuitry 406 may then transmit the one or more messages from the LLM circuitry 416 to the destination through any suitable technique. Examples of transmission may include, but are not limited to, sending an output message as the body of an email, sending the output message through a chat-bot service hosted on a website of the destination, using a text-to-voice to verbally pronounce the output message over a phone call with a representative of the destination, etc. In some examples, a second output message produced by the LLM circuitry 416 is based on how the destination responds to the transmission of a preceding, first output message.

The example destination determiner circuitry 406 determines if the destination will take the product. (Block 806). In some examples, the destination determiner circuitry 406 makes the determination based on communication with the destination as described in connection with block 804. In other examples, communication is not necessary because the return coordinator circuitry 112 can determine whether the destination will accept the product through other techniques. For example, the destination may publicly share policy information (via, for example, a website and/or a user agreement) that is interpretable by the destination determiner circuitry 406. In such examples, the destination determiner circuitry 406 may obtain, interpret, and/or apply the appropriate policies to implement block 806 without also implementing block 804. If the destination will not take the product (Block 806: No), control proceeds to block 814.

If the destination will take the product (Block 806: Yes), the example destination determiner circuitry 406 assigns a weight to the destination based on a prioritization scheme. (Block 808). The prioritization scheme refers to a set of parameters within the destination policy 422 that describe which destinations, if any, are generally more suitable to some final destinations than others. For example, suppose a managing organization has both a primary distribution center and a secondary distribution center within a region, where the secondary distribution center is only utilized if the primary distribution center is at or near full capacity. In such examples, the managing organization may store the preference in the destination policy 422 such that the destination determiner circuitry 406 assigns a higher weight to the primary distribution center over the secondary distribution center whenever the primary distribution center has available capacity. Advantageously, the prioritization scheme is configurable and can be changed by editing the destination policy 422 at any time. The managing organization may change the prioritization scheme for any reason, including but not limited to the addition or removal of a destination from a network, a change in internal policies, etc.

As used above and herein in connection with FIG. 8, weight refers to a value that represents the relative importance (e.g., significance, relevancy, etc.) of factors used to determine a destination for the item. In general, a first factor that is more important than a second factor may have a higher weight (e.g., a larger weight value) than the second factor. In such examples, the destination determiner circuitry 406 may prioritize candidate destinations that predominantly satisfy the first factor over candidate destinations that predominantly satisfy the second factor. In some examples, the weights may additionally or alternatively be referred to as scaling factors.

In some examples, the prioritization scheme of block 808 also reflects user preferences obtained through the application 106. For example, the user 102A may seek to sell the product to a friend within the marketplace 312, to return the product sustainably, etc. User preferences may additionally or alternatively reflect the particular return goals the user 102A holds as discussed above (e.g., the relative importance of maximizing a monetary compensating, minimizing delays, maximizing comfort, etc.) In such examples, the destination determiner circuitry 406 may determine initial weights based on one or more user preferences.

The example destination determiner circuitry 406 adjusts the weight of block 808 based on the payment (if any), that the destination will provide the user for the value of the product. (Block 810). As discussed above, maximizing a monetary return from the value of the product is a potential goal of the user 102A. Accordingly, the destination determiner circuitry 406 may implement block 808 by increasing the weight of destinations that will provide a relatively large amount of money (e.g., a refund) to the user. Additionally or alternatively, the destination determiner circuitry 406 may implement block 808 by decreasing the weights of destinations that will provide little or no monetary return for the value of the product.

The example destination determiner circuitry 406 adjusts the weight of block 808 based on the distance between the destination and the user. (Block 812). Generally, increasing the distance between a final destination and the user (e.g., the initial location of the product) results in the transit determiner circuitry 408 determining a transit plan that is more complex, more expensive, and/or slower to implement. Accordingly, the destination determiner circuitry 406 may implement block 808 by adjusting the weight of a destination to maintain an inverse proportionality between weight and distance.

The destination determiner circuitry 406 optionally adjusts the weights based on other factors besides those shown in blocks 810 and 812. (Block 813). For example, the destination determiner circuitry 406 may adjust weight of block 808 based on shipping attributes. Shipping attributes may include but are not limited to mass, dimension size, the initial location of the item, routing logic, type of goods (fragile, perishable, or hazardous materials), condition of goods, costs, carrier availability, etc.

The example destination determiner circuitry 406 determines whether to evaluate another destination. (Block 814). The destination determiner circuitry 406 may use any criteria within the destination policy 422 to determine whether to evaluate another destination. For example, the destination policy 422 may indicate a threshold number of destinations should be evaluated, destinations within a given region should be evaluated, destinations should be evaluated until a threshold amount of time has passed or the destination determiner circuitry 406 has consumed a given amount of compute resources, etc. If the destination determiner circuitry 406 does decide to evaluate another destination (Block 814: Yes), control returns to block 802 where the destination determiner circuitry 406 identifies another destination for evaluation.

If the example destination determiner circuitry 406 decides not to evaluate another destination (Block 814: No), the destination determiner circuitry 406 determines whether at least one of the identified destinations will take the product. (Block 816). If at least one of the identified destinations will take the product (Block 816: Yes), the destination determiner circuitry 406 selects a destination based on the weights. (Block 818). The destination determiner circuitry 406 may use any criteria within the destination policy 422 to determine how the weights should be used to select a final destination. In some examples, the destination determiner circuitry 406 may select the destination with the highest available weight. In other examples, the destination determiner circuitry 406 may use a machine learning model to determine a function that maps the various destinations and weights to a single output (e.g., the selection of a final destination). The example machine-readable instructions and/or operations 700 return to block 708 after block 818.

Alternatively, if none of the destinations will take the product (Block 820: No), the application manager circuitry 404 instructs the user 102A, via the application 106, to discard the product. (Block 820). The product may be discarded for any reason, including but not limited to the product containing perishable food, the product is too old or too damaged, etc. At block 820, the application manager circuitry 404 also cancels the return previously initiated by the user 120A because a final destination could not be determined.

The machine-readable instructions and/or operations 700 may end at block 820 and/or skip block 708 because there is no longer a need to determine a transit plan. However, in some examples, the QR code of block 704 may be scanned even after the return is canceled. In such examples, the return coordinator circuitry 112 still implements block 710 and provides a splash page as discussed further in connection with FIG. 10.

FIG. 9 is a flowchart representative of example machine-readable instructions and/or example operations that may be executed, instantiated, and/or performed by the return coordinator circuitry 112 of FIG. 1 to determine a transit plan for a product as described in FIG. 7. In particular, the flowchart of FIG. 9 is an example implementation of block 708 of FIG. 7.

Implementation of block 708 begins when the example transit determiner circuitry 408 identifies a path from the current location of the product 108 to the final destination. (Block 902). In some examples, the path includes the identification of one or more intermediate destinations between the current location and the final location.

The transit determiner circuitry 408 implements block 902 based on the transit policy 424. For example, the transit policy 424 may indicate that legs of the path that involve driving should remain on highways where practicable, avoid side-roads unless in last-mile deliveries, avoid left turns where practicable to save fuel, etc. The transit policy 424 may additionally or alternatively indicate that the transit determiner circuitry 408 should seek to minimize the total length of the path, identify paths that were similar to previously selected paths (to increase the probability that multiple products are transported together), etc.

The example transit determiner circuitry 408 identifies one or more delivery services 122 to move the product along the path. (Block 904). The transit determiner circuitry 408 identifies the delivery services 122 based on their respective policies and availability. In some examples, the transit determiner circuitry 408 also identifies delivery services based on preferences stored by the managing organization within the transit policy 424.

The example transit determiner circuitry 408 estimates the time required to complete transit along the path identified in block 902. (Block 906). The transit determiner circuitry 408 may use any suitable technique to determine a time estimate, including manual computation with speed limits and distances, estimates provided by the delivery services 122 or navigation services, etc.

The example transit determiner circuitry 408 estimates a shipping cost to complete transit along the path identified in block 902. (Block 908). The transit determiner circuitry 408 may determine the cost by communicating with the one or more identified delivery services to obtain an estimate for the cost of implementing their respective legs, and by computing a sum of the individual leg estimates.

The example transit determiner circuitry 408 determines whether to consider another transit path/delivery service combination. (Block 910). The destination determiner circuitry 406 may use any criteria within the transit policy 424 to determine whether to evaluate another destination. For example, the transit policy 424 may indicate a threshold number of paths should be evaluated, paths within a given region should be evaluated, paths should be evaluated until a threshold amount of time has passed or the destination determiner circuitry 406 has consumed a given amount of compute resources, etc. If the transit determiner circuitry 408 determines another combination should be considered (Block 910: Yes), control returns to block 902 where the transit determiner circuitry 408 identifies another path from the current location of the product 108 to the final destination.

If the transit determiner circuitry 408 determines no further combinations should be considered (Block 910: No), the transit determiner circuitry 408 selects a path/delivery service combination based on the estimations. (Block 912). The transit determiner circuitry 408 may use any suitable technique to determine the relative importance of the estimations. In some examples, the transit determiner circuitry 408 selects a path/delivery service combination based on other factors besides those shown in blocks 810 and 812. As used above and herein, the selected path and corresponding delivery services may be collectively referred to as a transit plan.

The transit determiner circuitry 408 provides instructions to initiate the selected transit plan. (Block 914). For example, the transit determiner circuitry 408 may provide user-facing instructions to the application manager circuitry 404 for display on a client device 104A. In some examples, the transit determiner circuitry 408 may additionally communicate with one or more delivery services 122 via the network interface circuitry 402 to schedule the transportation of the product 108 on various legs of the transit plan. As used herein, a leg of a transit plan may refer to the transportation of a product from one destination to a subsequent destination, regardless of whether either destination is an initial, intermediate, or final destination. The example machine-readable instructions and/or example operations 700 return to block 710 after block 914.

FIG. 10 is a flowchart representative of example machine-readable instructions and/or example operations that may be executed, instantiated, and/or performed by the return coordinator circuitry of FIG. 1 to respond to a request to access a webpage linked to a QR code as described in FIG. 7. In particular, the flowchart of FIG. 10 is an example implementation of block 710 of FIG. 7.

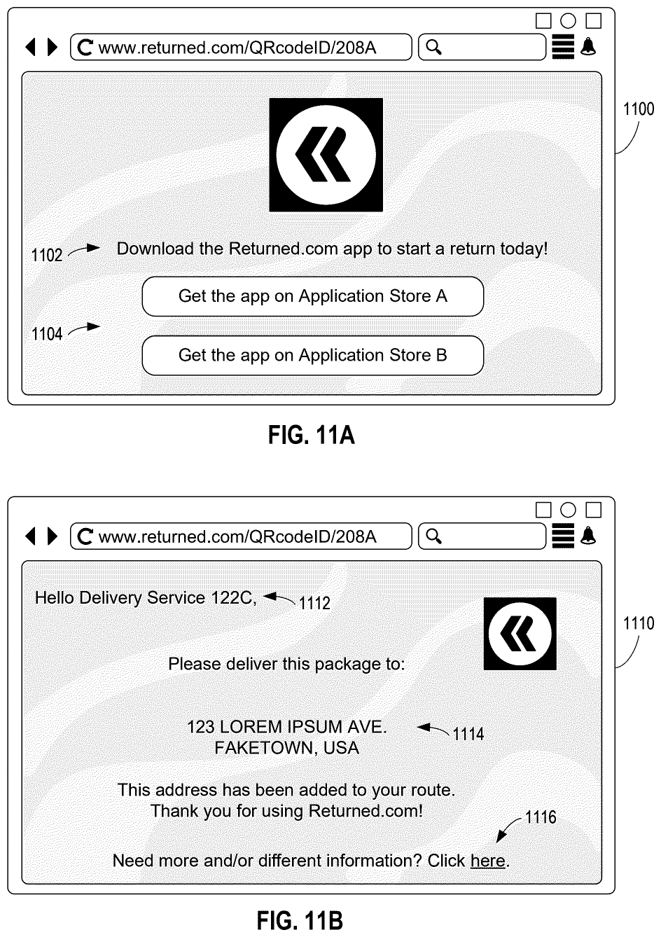

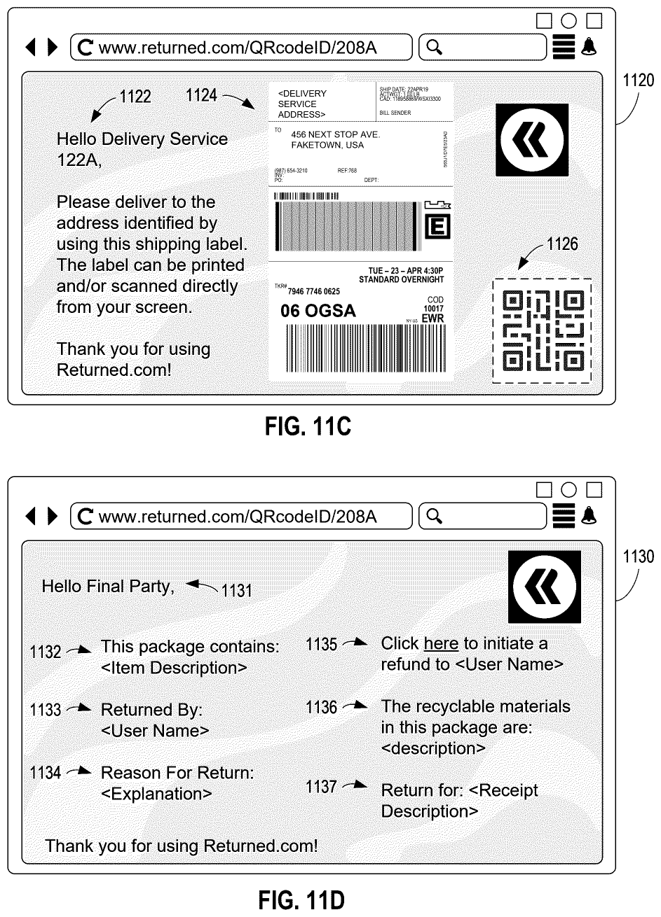

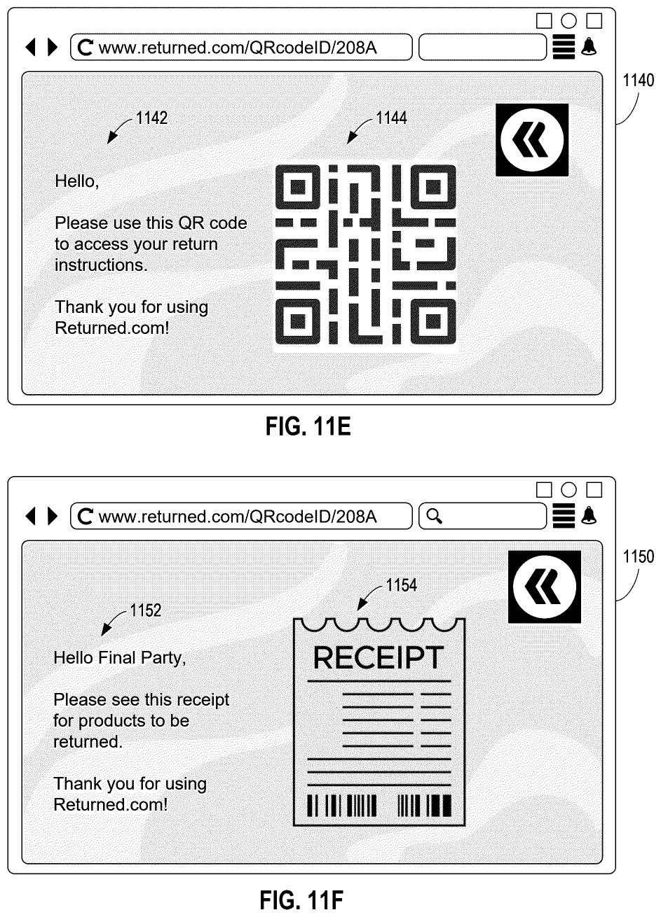

In some examples, the device requesting the URL linked to the QR code also has the application 106 installed at the time of the URL request. In such examples, the device can open the application 106 in response to a user generating a request for a URL (e.g., scanning the QR code). In other examples, the device requesting the URL linked to the QR code does not have the application 106 installed at the time of the URL request. Accordingly, the return coordinator circuitry 112 may provide information to the requesting device (as discussed further below in connection with FIG. 10) through the application 106 or through any other suitable interface (e.g., through a web browser as shown in FIGS. 11A-11F).

Implementation of block 710 begins when the QR manager circuitry 418 determines whether a product is currently associated with the QR code. (Block 1002). As discussed above, the QR manager circuitry 418 may associate a product with a QR code by connecting the URL identifier value of the QR code with product information within the return logs 426. The QR manager circuitry 418 may then disassociate the QR code with the product for any reason, including but not limited to the completion of the return (e.g., the product reached the final destination), the cancellation of the return, the passage of a threshold amount of time, etc. Accordingly, a given QR code may or may not be associated with a product at any point in time.

If a product is not associated with the QR code (Block 1002: No), the example QR manager circuitry 418 provides a splash page the device that requested access to the URL. (Block 1004). Rather than providing information about the product 108 or the user 102A, the splash page directs viewers to the application 106. Once logged into the application 106, the return coordinator circuitry 112 may obtain information to associate with QR code with a product and/or user. The example splash page of block 1004 is discussed further in connection with FIG. 11A.

If a product is associated with the QR code (Block 1002: Yes), the example QR manager circuitry 418 determines whether the QR code has expired. (Block 1006). In some examples, the QR manager circuitry 418 causes the QR code to expire after a threshold amount of time and/or the satisfaction of one or more conditions (e.g., the product 108 was provided to the final destination, the product 108 was marked as lost, etc.). If the QR code is expired (Block 1006: Yes), control returns to block 1004 where the QR manager circuitry 418 provides a splash page to the requesting device. By providing a splash page when the QR code is expired, the managing organization limits the ability for external parties to access potentially sensitive information by scanning the QR code. In some examples, the QR manager circuitry 418 causes a QR code to expire by disassociating the URL identifier value from any returns as described above.

If the QR code has not expired (Block 1006: No), the example QR manager circuitry 418 determines whether the product 108 is in transit. (Block 1008). The product 108 may be considered in transit if it has not yet reached the final destination. The QR manager circuitry 418 may confirm the product 108 has reached the final destination based on any number of factors, including but not limited to the passage of time, a location tracker, a report provided by a delivery service 122A, a report provided by a final party, etc. If the product 108 is not in transit (Block 1008: No), control proceeds to block 1014.

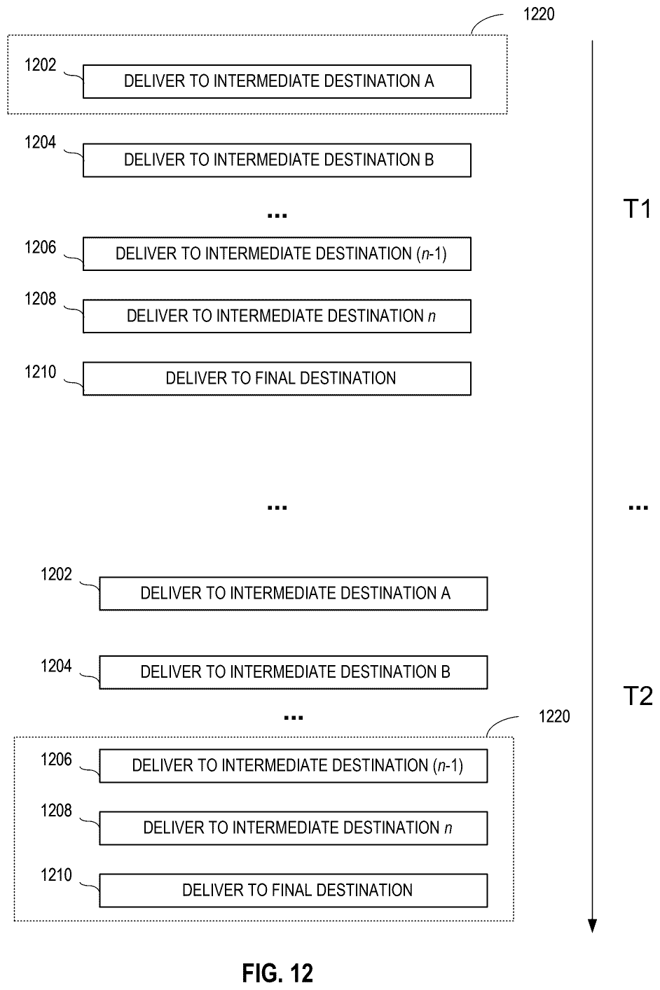

If the product 108 is in transit (Block 1008: Yes), the QR manager circuitry 418 provides delivery-facing transit information to the device requesting access to the URL. (Block 1010). Because the QR code may be scanned any number of times, the QR manager circuitry 418 may iterate through the flowchart of FIG. 10 any number of times. Advantageously, the QR manager circuitry 418 may change the amount and/or format of information presented to the requesting device between subsequent iterations of block 1010 based on the contextual information available at the time. Block 1010 is discussed further in connection with FIGS. 12 and 13.

The QR manager circuitry 418 determines whether final party instructions have been requested. (Block 1012). A device may request final party instructions by accessing the URL and clicking a link on the subsequent webpage. While block 1012 may only be implemented if the QR manager circuitry 418 determines the product 108 is still in transit (e.g., the final party has not yet received the product), in some examples, a single individual may require both delivery facing transit information and information generally provided to a final party information. Accordingly, by implementing block 1012, the QR manager circuitry 418 provides individuals the ability to request and obtain additional information than was originally provided using the URL. If final party instructions have not been provided (Block 1012: No), the machine-readable instructions and/or operations 700 end.

If the product is not in transit (Block 1008: No), or if final party instructions have been requested (Block 1012: Yes), the QR manager circuitry 418 provides final instructions. (Block 1014). Final party instructions may refer to any type of information used by a representative of the final destination (e.g., a final party). For example, final party instructions may enable a final party to determine what actions to take, if any, following receipt of the product 108. The machine-readable instructions and/or operations 700 end after block 1014.

FIGS. 11A-11F are illustrative examples of information that may be displayed in response to a request to access a URL as described in FIG. 10. In particular, FIGS. 11A-11F show example visual interfaces that a web browser may present after a device requests access to the URL identified by QR code 208A.

FIG. 11A represents what an individual may see if the QR manager circuitry 418 provides a splash page at block 1004 of FIG. 10. FIG. 11A includes an example visual interface 1100, example text 1102, and example links 1104.

The QR manager circuitry 418 populates the example visual interface 1100 with text 1102 that encourages individuals to download and use the application 106. Similarly, the links 1104 point to app stores (e.g., webpages and/or software programs) where the application 106 can be downloaded. In some examples, the links 1104 available in the visual interface 1100 change based on the operating-system of the device requesting access to the URL.

In some examples, the device requesting access to the URL may already have the application 106 installed when the QR manager circuitry 418 provides the splash page at block 1004. In such examples, the webpage may cause the local web browser to communicate with the operating system of the requesting device and automatically open the application 106. Accordingly, the visual interface 1100 may include a loading graphic and/or not provide information when the application 106 is already downloaded on the requesting device.

FIG. 11B is a first example of what an individual may see if the QR manager circuitry 418 provides delivery-facing transit information at block 1010 of FIG. 10. FIG. 11B includes an example visual interface 1110, and example text 1112, 1114, and 1116.

In the example of FIG. 11B, the QR manager circuitry 418 populates the visual interface 1100 with the text 1102, which identifies a particular delivery service 122C (e.g., a driver working for a rideshare service). The QR manager circuitry 418 may show the text 1102 in the visual interface 1100 based on a confirmation or prediction that, at the time the QR code 208A was scanned, delivery service 122C is responsible for implementing the current leg of the transit plan. That is, at the time the QR code 208A was scanned, the delivery service 122C may be confirmed or predicted to be picking up the corresponding product, transporting the product, or dropping the product off at a destination. The return coordinator circuitry 112 may confirm or predict the status of a return (e.g., where the product is currently located, which leg of the transit plan is currently being implemented, etc.) based on any number of conditions as discussed further below in connection with FIG. 12.

In addition to identifying the delivery service 112C in text 1112, the example of FIG. 11B shows that the QR manager circuitry 418 uses the foregoing confirmation or prediction to present the text 1114, which is transit information specific to the delivery service 122C. The information is specific to the delivery service 122C because it identifies the destination (which could be an intermediate or the final destination) where the delivery service 122C is taking the product associated with QR code 208A. The information may also be specific to the delivery service 122C because the information is presented in a format used by the delivery service 122C (e.g., a mail address in FIG. 11B).

In some examples, the delivery service 122C requires additional information to transport the product beyond what is provided in the text 1114. In other examples, someone other than a delivery service 122C scans the QR code 208A and is provided with the visual interface 1110. As such, the QR manager circuitry 418 provides the text 1116, which includes a link where individuals can submit a request for additional and/or different information.

When the link in text 1116 is pressed, the QR manager circuitry 418 may provide additional delivery-facing transit information and/or final party instructions to the visual interface 1110 depending on available contextual information (e.g., where the product associated with QR code 208A is currently located, the identity of the individual that clicked the link, etc.) In some examples, the return coordinator circuitry 112 performs one or more authentication operations to confirm the identity of the individual that clicked the link before providing the additional and/or different information. The text 1116 is one example implementation of how the QR manager circuitry 418 evaluates block 1012 of FIG. 10.

FIG. 11C is a second example of what an individual may see if the QR manager circuitry 418 provides delivery-facing transit information at block 1010 of FIG. 10. FIG. 11C includes an example visual interface 1120, example text 1122, an example shipping label 1124, and an example QR code 1126.

In the example of FIG. 11C, the QR manager circuitry 418 populates the visual interface 1120 with the text 1122, which identifies a particular delivery service 122A (e.g., a third-party shipping company). The QR manager circuitry 418 may show the text 1112 in the visual interface 1120 based on a confirmation or prediction that, at the time the QR code 208A was scanned, delivery service 122A is responsible for implementing the current leg of the transit plan as discussed above.

In addition to identifying the delivery service 122A in text 1122, the example of FIG. 11C shows that the QR manager circuitry 418 uses the foregoing confirmation or prediction to present transit information specific to the delivery service 122A within the visual interface 1120. For example, the visual interface 1120 may include the shipping label 1124, which is designed and formatted by delivery service 122A but is populated with an address specific to the product associated with the QR code 208A.

Additionally or alternatively, the visual interface 1120 may include the QR code 1126. The QR code 1126 is different from the QR code 208A in that the two codes point to two different webpages. While the QR code 208A points to a webpage hosted by the return coordinator circuitry 112 and having a particular identification value in its URL, the QR code 1126 points to a webpage that is hosted by the delivery service 122A and provides transit information for the product associated with QR code 208A. Notably, the amount and format of information found in the shipping label 1124 and/or through a scan of the QR code 1126 is determined by the delivery service 122A, which is independent and separate from the managing organization. Accordingly, the shipping label 1124 and/or the QR code 1126 enables the delivery service 122A to transport the product associated with QR code 208A using their own processes and workflows.

When implementing block 1010, the QR manager circuitry 418 may include some or all of the information presented in the examples of FIGS. 11B and 11C. Similarly, the QR manager circuitry 418 may identify multiple different delivery services 122, not identify any delivery service, and/or present different information when implementing block 1010. The operations made by the QR manager circuitry 418 at block 1010 are discussed further in connection with FIGS. 12 and 13.

FIG. 11D is a first example of what an individual may see if the QR manager circuitry 418 provides final party instructions at block 1014 of FIG. 10. FIG. 11D includes an example visual interface 1130, and example text 1131, 1132, 1133, 1134, 1135, 1136, and 1137.

A determination (e.g., through either confirmation or prediction) that the product associated with QR code 208A is no longer in transit (block 1008 of FIG. 10: No) implies that a transit package, containing a product and including the QR code 208A on an external face, is determined to have reached the final destination. Accordingly, the QR manager circuitry 418 provides the text 1131 in the visual interface 1130 to identify the final party (e.g., a representative of the final destination). The QR manager circuitry 418 may obtain identification information through the destination determiner circuitry 406, which previously selected the final destination.

The QR manager circuitry 418 additionally presents one or more of the text 1132-1137 on the visual interface 1130 based on who the final party is (e.g., a representative of the retailer 116, the manufacturer 118, the recycling center 120, one of the users 102 who bought the product through the marketplace 312, etc.). For example, the text 1132 provides a description of the product associated with the QR code 208A, the text 1133 provides information describing the user who returned the product, the text 1134 provides a reason the user entered into the application 106 describing why the product was returned, the text 1135 provides a link enabling the final party to communicate with the finance manager circuitry 410 and initiate a refund to the user, the text 1136 provides a description of the recyclable materials within the product and/or transit package, and the text 1137 provides an order number and/or receipt reference number. In some examples, the text 1137 additionally or alternatively includes a Return Merchandise/Material Authorization (RMA) value.

In some examples, the return coordinator circuitry 112 is unable to identify one or more pieces of information shown in FIG. 11B (e.g., the user did not provide a reason for return, the composite materials of the product could not be identified, etc.). Accordingly, the QR manager circuitry 418 determines what information to provide to the final party based on both who the final party is and what information is available.

FIG. 11E is a second example of what an individual may see if the QR manager circuitry 418 provides final party instructions at block 1014 of FIG. 10. FIG. 11E includes an example visual interface 1140, example text 1142, and an example QR code 1144. In some examples, the QR manager circuitry 418 may additionally or alternatively provide the visual interface 1140 to a delivery service as part of the delivery-facing transit information of block 1010.

Like the text 1131 of FIG. 11D, the QR manager circuitry 418 may provide text 1142 to identify a representative. In some examples, the representative is a final party identified using information from the destination determiner circuitry 406. In other examples, the representative is associated with one of the delivery services 122. In yet other examples, the text 1142 does not identify a representative.

The example of FIG. 11D also includes the QR code 1144. The QR code 1144 is different from the QR code 208A in that the two codes point to two different webpages. While the QR code 208A points to a webpage hosted by the return coordinator circuitry 112 and having a particular identification value in its URL, the QR code 1144 points to a webpage that is hosted by the final destination and return information for the product associated with QR code 208A. Accordingly, in some examples, the QR code 1114 may be referred to as an additional QR code or as a separate QR code. Notably, the amount and format of information found through a scan of the QR code 1144 is determined by the final destination, which is independent and separate from the managing organization. Accordingly, the QR code 1144 enables the final destination to process the product associated with QR code 208A (e.g., recycle, re-sell, refund, etc.) using their own processes and workflows.

FIG. 11F is a third example of what an individual may see if the QR manager circuitry 418 provides final party instructions at block 1014 of FIG. 10. FIG. 11F includes an example visual interface 1150, example text 1152, and an example receipt 1154.

Like the text 1131 and 1142 of FIGS. 11C and 11D, the QR manager circuitry 418 provides text 1152 to identify the final party using information from the destination determiner circuitry 406. The example of FIG. 11F also includes the receipt 1154, which is a digital copy of the receipt provided to the user when the returned product was originally purchased. The return coordinator circuitry 112 may obtain the receipt by scraping an email inbox corresponding to the user, by previously using the LLM circuitry and the product description to request the receipt from the financial destination, etc. Notably, the amount and format of the receipt 1154 is determined by the final destination, which is independent and separate from the managing organization. Accordingly, the receipt 1154 enables the final destination to return the product associated with QR code 208A using their own processes and workflows.

FIG. 12 is an illustrative example of providing delivery facing transit information as described in FIG. 10. FIG. 12 includes a timeline with two timestamps T1 and T2. Each timestamp includes example instructions 1202, 1204, 1206, 1208, 1210, and an example window 1220.

The transit plan developed by the transit determiner circuitry 408 includes an ordered list of destinations such that when one or more delivery services 122 transport a product 108 between destinations in the specified order, the product 108 reaches the final destination selected by the destination determiner circuitry 406. Accordingly, the QR manager circuitry 418 may represent the transit plan on a visual interface using an ordered set of instructions. In the example of FIG. 12, the instructions 1202 enable a delivery service to complete the first leg of the transit plan and deliver the product to a first intermediate destination. Similarly, the instructions 1204 enable a delivery service to complete the second leg of the transit plan and deliver the product to a second intermediate destination, . . . , the instructions 1208 enable a delivery service to complete the nth leg of the transit plan and deliver the product to an nth intermediate destination, and the instructions 1210 enable a delivery service to complete the final leg of the transit plan and deliver the product to a final intermediate destination.

While the QR manager circuitry 418 has the option to provide any amount of the instructions 1202-1208 whenever a device requests scans the QR code 208A and requests access to a URL, providing all of the instructions 1202-1208 at once may both crowd the visual interface and confuse the individual requesting information. Therefore, the QR manager circuitry 418 provides a subset of adjacent instructions for presentation on a visual interface at any point in time. As used in examples herein, the subset of adjacent instructions chosen for presentation is referred to as the example window 1220.

Advantageously, the QR manager circuitry 418 may move or resize the window 1220 at any time. The movement of the window 1220 may be modeled as a First In First Out (FIFO) buffer in that, if the window is 1220 is moved without also being resized, then the QR manager circuitry 418 both removes the instruction that had been on the visual interface for the longest period and adds the next instruction in the order set to the visual interface. By moving the window 1220 without resizing, the QR manager circuitry 418 maintains the same amount of information on the visual interface while also updating the content presented therein. The QR manager circuitry 418 may choose to move the window 1220 for any reason as discussed further below.

The QR manager circuitry 418 resizes the window 1220 in order to provide more or less information to the visual interface than was previously presented. In general, the managing organization may seek to minimize the size of the window 1220 so that only information relevant to the party currently scanning the QR code 208A is presented. Such minimization reduces complexity for the party scanning the QR code 208A and mitigates the sharing of potentially sensitive information within other instructions. For example, at T1, the QR manager circuitry 418 only shows the instructions 1202 to devices that request access to the URL. The visual interface 1110 of FIG. 11B is one example implementation of what an individual may see at T1.

In some examples, the return coordinator circuitry 112 may be unable to precisely determine the transit status of a product because packages can be delayed or lost, and because the delivery services 122 may provide limited amounts of tracking information. When the exact transit status of a product is unknown, the QR manager circuitry 418 may make a prediction of the transit status and scale the size of the window 1220 based on the confidence of the prediction. Therefore, if confidence in the accuracy of transit status is relatively low, the QR manager circuitry 418 can increase the size of window so that individuals associated multiple adjacent transit legs can scan the QR code 208A and obtain relevant information. More generally, the QR manager circuitry 418 may change the size of the window in response to a confirmed or predicted change in transit status.

At T2, the QR manager circuitry 418 has both expanded the size of the window 1220 and moved the window 1220 relative to T1.

Accordingly, at T2, a device requesting access to the URL associated with QR code 208A receives instructions 1206-1210, thereby obtaining information to complete the (n−1)th, nth, and final legs of the transit plan.

The return coordinator circuitry 112 may increase or decrease the confidence of their transit status for any number of reasons. For example, suppose the first leg of the transit plan is implemented by delivery service 122A, the delivery service 122A estimates the first leg will require a certain amount of time to complete, and that a different delivery service 122B is scheduled to implement the second leg of the transit plan. In such example, the return coordinator circuitry 112 may decrease a confidence value in the accuracy of the transit status if the delivery service 122A fails to mark the product as delivered to the first intermediate destination within a reasonable window surrounding the estimated completion time. The confidence value decreases in such a situation because the lack of a confirmation from delivery service 122A makes the managing organization less sure where the product is currently located and when the product will reach the final destination. The decreased confidence value may cause the QR manager circuitry 418 to increase the size of the window 1220 so that instructions relating to both the first and second legs of the transit plan are simultaneously available to anyone who scans the QR code 208A.

Suppose further that, within the same example, delivery service 122B reports the product as in-transit along the second leg of the transit plan, even though the delivery service 122A never marked the first leg of the transit plan completed. In such an example, it is likely that the product did reach the first intermediate destination and is now on the second leg. Possible reasons for delivery service 122A not marking the first leg as complete including an employee forgetting to enter information into the system, an error in the tracking information provided by delivery service 122A, etc. Accordingly, the return coordinator circuitry 112 may increase a confidence value of the transit status, decrease the size of the window 1220, and show only instructions for the second leg to anyone who scans the QR code 208A. Later, if the delivery service 122B marks the second leg of the transit plan complete, the QR manager circuitry 418 may move the window 1220 without resizing so that only instructions for the third leg of the transit plan are provided to requesting devices.

More generally, the return coordinator circuitry 112 may move or resize the window 1220 for any reason. For example, the QR manager circuitry 418 may cause presentation of instructions 1206-1210 together if the last three legs of the transit plan are implemented by the same delivery service 122A, without regards to any confidence value of the transit status. The QR manager circuitry 418 may make any number of adjustments to the size and/or position of the window 1220 before, after, and/or in-between T1 and T2.

FIG. 13 is a flowchart representative of example machine-readable instructions and/or example operations that may be executed, instantiated, and/or performed by the return coordinator circuitry 112 of FIG. 1 to provide delivery facing transit information as described in FIG. 10. In particular, the flowchart of FIG. 10 is an example implementation of how block 1010 of FIG. 10 is implemented.

Implementation of block 1010 begins when the QR manager circuitry 418 determines an ordered list of destinations. (Block 1302). The QR manager circuitry 418 determines the contents and order of the list based on the intermediate destinations within the transit plan produced by the transit determiner circuitry 408. The instructions 1202-1208 of FIG. 12 are an example implementation of the ordered list of block 1302.

The example QR manager circuitry 418 selects the window 1220 from the ordered list of destinations. (Block 1304). In examples described herein, the window is a subset of adjacent instructions within the ordered list (e.g., instructions with indices (n−1) and (n+1) cannot both be present in the window 1220 unless the instruction with index n is also present). In other examples, the window 1220 refers to any subset of instructions from the list regardless of index. In some examples, the initial selection of the window at block 1304 includes a first instruction in the list (e.g., instructions corresponding to the first leg of the transit plan).

The example QR manager circuitry 418 determines whether to update the webpage being accessed by a requesting device in FIG. 10. (Block 1306). The QR manager circuitry 418 may update the webpage for any reason, including but not limited to the passage of time, communications from one or more delivery services 122 associated with the transit plan, a change in the confidence of the transit status, etc. If the QR manager circuitry 418 decides not to update the webpage (Block 1306: No), control proceeds to block 1314.

If the QR manager circuitry 418 decides to update the webpage (Block 1306: Yes), the QR manager circuitry 418 optionally moves the window along the ordered list. (Block 1308). The move is optional because the webpage may be updated by changing one or both of the size and position of the window 1220. When the QR manager circuitry 418 does move the window at block 1308, the subset of instructions from the ordered list change but the size of the subset remains unaltered.

The QR manager circuitry 418 optionally resizes the window. (Block 1310). To resize the window 1220, the QR manager circuitry 418 adds or removes instructions from either end of the ordered subset. Accordingly, both the contents and size of the subset may change at block 1310.

The QR manager circuitry 418 causes the display of transit information for destinations identified in the window. (Block 1312). To do so, the QR manager circuitry 418 provides, via the network interface circuitry 402 and network 124, instructions within the window to the device requesting access at block 710. The requesting device may then present the information using any suitable technique to view a webpage (e.g., using a web browser). Examples of such a display include but are not limited to the visual interfaces 1110 and 1120 of FIGS. 11B and 11C.

The QR manager circuitry 418 determines whether the product corresponding to the webpage has reached its final destination. (Block 1314). If the product has not reached the final destination (Block 1314: No), control returns to block 1306 where the QR manager circuitry 418 determines whether to update the webpage again. Accordingly, the QR manager circuitry 418 may update the webpage any number of times. If the product has reached the final destination (Block 1314: Yes), the machine-readable instructions and/or operations 700 return to block 1012 of FIG. 10.

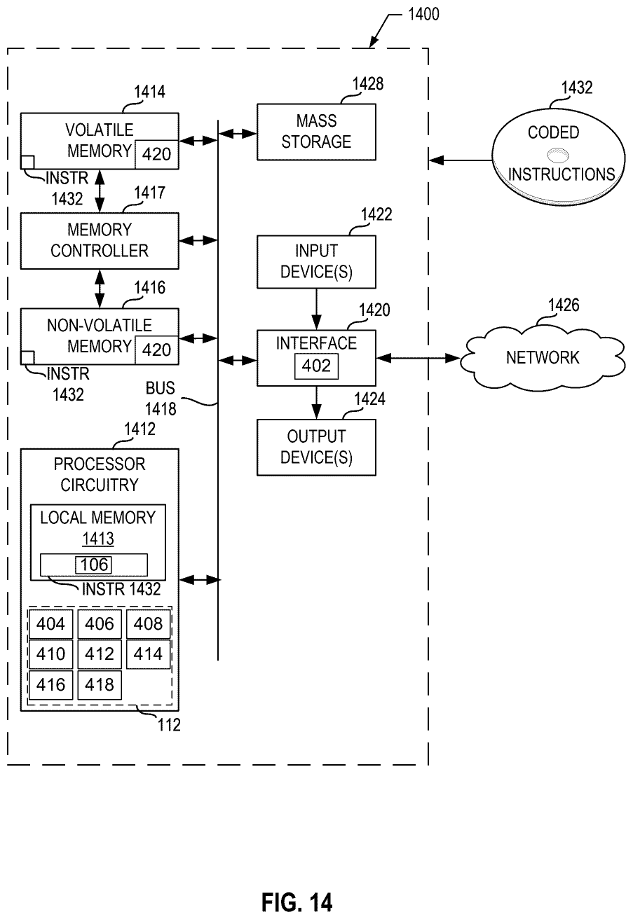

FIG. 14 is a block diagram of an example programmable circuitry platform 1400 structured to execute and/or instantiate the example machine-readable instructions and/or the example operations of FIGS. 5-10 and 13 to implement the return coordinator circuitry 112 and/or client device 104 of FIGS. 3 and 4. The programmable circuitry platform 1400 can be, for example, a server, a personal computer, a workstation, a self-learning machine (e.g., a neural network), a mobile device (e.g., a cell phone, a smart phone, a tablet such as an iPad™), an Internet appliance, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the application manager circuitry 404, the destination determiner circuitry 406, the transit determiner circuitry 408, the finance manager circuitry 410, the marketplace circuitry 412, the large language interface circuitry 414, the LLM circuitry 416, and the QR manager circuitry 418.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1432, which may be implemented by the machine-readable instructions of FIGS. 5-10 and 13, may be stored in the mass storage device 1428, in the volatile memory 1414, in the non-volatile memory 1416, and/or on at least one non-transitory computer readable storage medium such as a CD or DVD which may be removable. In this example, the machine-readable instructions 1432 include the application 106.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 5-10 and 14 to effectively instantiate the circuitry of FIG. 2 as logic circuits to perform operations corresponding to those machine-readable instructions. In some such examples, the circuitry of FIGS. 3 and 4 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions and/or operations represented by the flowcharts of FIGS. 5-10 and 14.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

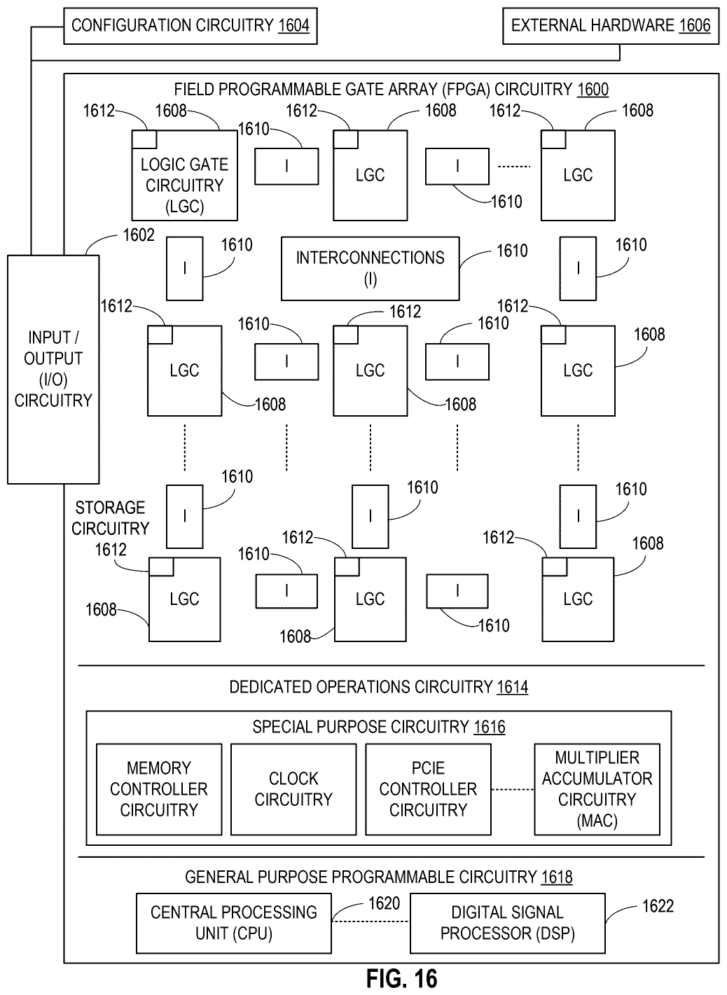

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine-readable instructions represented by the flowchart(s) of FIGS. 5-10 and 13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 5-10 and 13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-10 and 13. As such, the FPGA circuitry 1600 may be configured and/or structured to effectively instantiate some or all of the operations/functions corresponding to the machine-readable instructions of the flowchart(s) of FIGS. 5-10 and 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIGS. 5-10 and 13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIGS. 5-10 and 13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine-readable instructions represented by the flowchart(s) of FIGS. 5-10 and 13 to perform first operation(s)/function(s), the FPGA circuitry 1600 of FIG. 16 may be configured and/or structured to perform second operation(s)/function(s) corresponding to a second portion of the machine-readable instructions represented by the flowcharts of FIGS. 5-10 and 13, and/or an ASIC may be configured and/or structured to perform third operation(s)/function(s) corresponding to a third portion of the machine-readable instructions represented by the flowcharts of FIGS. 5-10 and 13.

It should be understood that some or all of the circuitry of FIGS. 3 and 4 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIGS. 3 and 4 may be instantiated, for example, in one or more threads executing concurrently and/or in series. For example, the microprocessor 1500 of FIG. 15 may execute machine-readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIGS. 3 and 4 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

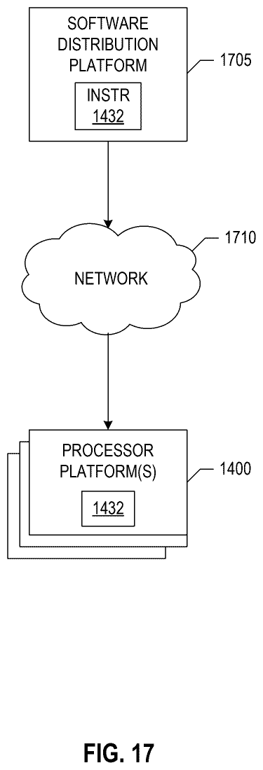

A block diagram illustrating an example software distribution platform 1705 to distribute software such as the example machine-readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine-readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine-readable instructions 1432, which may correspond to the example machine-readable instructions of FIGS. 5-10 and 13, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1432 from the software distribution platform 1705. For example, the software, which may correspond to the example machine-readable instructions of FIGS. 5-10 and 13, may be downloaded to the example programmable circuitry platform 1400, which is to execute the machine-readable instructions 1432 to implement the return coordinator circuitry 112 and/or client device 104. In some examples, one or more servers of the software distribution platform 1705 periodically offer, transmit, and/or force updates to the software (e.g., the example machine-readable instructions 1432 of FIG. 14) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable the transportation of products in a manner that reduces complexity for associated with the initialization, transportation, and receipt of a returned product. Disclosed systems, apparatus, articles of manufacture, and methods improve the efficiency of using a computing device by hosting a webpage that is linked to a particular return, and by affixing a QR code that points to the webpage to the outside of a transit package. Accordingly, return coordination circuitry 112 may provide different information to a device requesting access to the URL based on whether a product is currently associated, whether the QR link is expired, the confirmed or predicted transit status of the product, associated confidence values, or any other parameters. Accordingly, various individuals associated with the initialization, transportation, and receipt of a returned product can scan the same QR code on the outside of the transit package to obtain different information relevant to them. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to coordinate returns using QR codes are disclosed herein. Further examples and combinations thereof include the following.

Example 1 includes a non-transitory machine-readable storage medium comprising instructions to cause programmable circuitry to at least access a request based on a scan of a Quick Response (QR) code, the request including an identifier of the QR code, determine whether the identifier is associated with an item for delivery, after a determination that the identifier is not associated with the item, cause display of a first user interface for association of the identifier with the item, and after a determination that the identifier is associated with the item, cause display of a second user interface to present transit information corresponding to the item.

Example 2 includes the non-transitory machine-readable storage medium of example 1, wherein the QR code is printed on a transit package.

Example 3 includes the non-transitory machine-readable storage medium of example 2, wherein the transit package is separate from a previous package in which the item was shipped.

Example 4 includes the non-transitory machine-readable storage medium of example 2, wherein the transit package is a polybag.

Example 5 includes the non-transitory machine-readable storage medium of example 1, wherein the QR code is printed on a sticker that is to be affixed onto a transit package, a user to place the item in the transit package for delivery.

Example 6 includes the non-transitory machine-readable storage medium of example 1, wherein the QR code is printed on a sticker that is to be affixed directly onto the item.

Example 7 includes the non-transitory machine-readable storage medium of example 1, wherein the instructions cause the programmable circuitry to determine a transit plan for the item, and cause display of the second user interface to provide the transit information based on a status of the delivery relative to the transit plan.

Example 8 includes the non-transitory machine-readable storage medium of example 7, wherein the transit plan includes an intermediate destination between an initial location of the item and a final destination, and the instructions cause the programmable circuitry to, in response to a change in the status of the delivery, cause display of the intermediate destination on the second user interface.

Example 9 includes the non-transitory machine-readable storage medium of example 7, wherein the instructions cause the programmable circuitry to determine the item has reached the final destination, and cause display of product information using the second user interface.

Example 10 includes the non-transitory machine-readable storage medium of example 9, wherein the product information includes one or more of a description of the item, a name of a person who initiated the delivery, a reason for the delivery, a link to initiate a refund for a value of the item, an additional QR code, or information from a receipt.

Example 11 includes the non-transitory machine-readable storage medium of example 1, wherein the transit information includes one or more of an address, a shipping label, or an additional QR code, and the instructions cause the programmable circuitry to determine a type of transit information to provide based on a delivery service selected to transport the item.

Example 12 includes the non-transitory machine-readable storage medium of example 1, wherein the instructions cause the programmable circuitry to associate the QR code with a user-initiated action.

Example 13 includes the non-transitory machine-readable storage medium of example 12, wherein the user-initiated action is a return of an item.

Example 14 includes the non-transitory machine-readable storage medium of example 12, wherein the user-initiated action is a shipment of an item.

Example 15 includes the non-transitory machine-readable storage medium of example 12, wherein the QR code is associated with transit information.

Example 16 includes the non-transitory machine-readable storage medium of example 12, wherein the programmable circuitry is to facilitate execution of the user-initiated action.

Example 17 includes an apparatus to facilitate item delivery, the apparatus comprising interface circuitry, machine readable instructions, and programmable circuitry to at least one of instantiate or execute the machine readable instructions to access a request based on a scan of a Quick Response (QR) code, the request including an identifier of the QR code, determine whether the identifier is associated with an item for delivery, after a determination that the identifier is not associated with the item, cause display of a first user interface for association of the identifier the item, and after a determination that the identifier is associated with the item, cause display of a second user interface to present transit information corresponding to the item.

Example 18 includes the apparatus of example 17, wherein the QR code is printed on a transit package.

Example 19 includes the apparatus of example 18, wherein the transit package is separate from a previous package in which the item was shipped.

Example 20 includes the apparatus of example 18, wherein the transit package is a polybag.

Example 21 includes the apparatus of example 17, wherein the QR code is printed on a sticker that is to be affixed onto a transit package, a user to place the item in the transit package for delivery.

Example 22 includes the apparatus of example 17, wherein the QR code is printed on a sticker that is to be affixed directly onto the item.

Example 23 includes the apparatus of example 17, wherein the programmable circuitry is to determine a transit plan for the item, and cause display of the second user interface to provide the transit information based on a status of the delivery relative to the transit plan.

Example 24 includes the apparatus of example 23, wherein the transit plan includes an intermediate destination between an initial location of the item and a final destination, and the programmable circuitry is to, in response to a change in the status of the delivery, cause display of the intermediate destination on the second user interface.

Example 25 includes the apparatus of example 23, wherein the programmable circuitry is to determine the item has reached the final destination, and cause display of product information using the second user interface.

Example 26 includes the apparatus of example 25, wherein the product information includes one or more of a description of the item, a name of a person who initiated the delivery, a reason for the delivery, a link to initiate a refund for a value of the item, an additional QR code, or information from a receipt.

Example 27 includes the apparatus of example 17, wherein the transit information includes one or more of an address, a shipping label, or an additional QR code, and the instructions cause the programmable circuitry to determine a type of transit information to provide based on a delivery service selected to transport the item.

Example 28 includes the apparatus of example 17, wherein the programmable circuitry is to associate the QR code with a user-initiated action.

Example 29 includes the apparatus of example 28, wherein the user-initiated action is a return of an item.

Example 30 includes the apparatus of example 28, wherein the user-initiated action is a shipment of an item.

Example 31 includes the apparatus of example 28, wherein the QR code is associated with transit information.

Example 32 includes the apparatus of example 28, wherein the programmable circuitry is to facilitate execution of the user-initiated action.

Example 33 includes a method to facilitate item delivery, the method comprising accessing a request based on a scan of a Quick Response (QR) code, the request including an identifier of the QR code, determining whether the identifier is associated with an item for delivery, after a determination that the identifier is not associated with the item, causing display of a first user interface for association of the identifier with the item, and after a determination that the identifier is associated with the item, cause display of a second user interface to present transit information corresponding to the item.

Example 34 includes the method of example 33, wherein the QR code is printed on a transit package.

Example 35 includes the method of example 34, wherein the transit package is separate from a previous package in which the item was shipped.

Example 36 includes the method of example 34, wherein the transit package is a polybag.

Example 37 includes the method of example 33, wherein the QR code is printed on a sticker that is to be affixed onto a transit package, a user to place the item in the transit package for delivery.

Example 38 includes the method of example 33, wherein the QR code is printed on a sticker that is to be affixed directly onto the item.

Example 39 includes the method of example 33, further including determine a transit plan for the item, and causing display of the second user interface to provide the transit information based on a status of the delivery relative to the transit plan.

Example 40 includes the method of example 39, wherein the transit plan includes an intermediate destination between an initial location of the item and a final destination, and the method further includes, in response to a change in the status of the delivery, causing display of the intermediate destination on the second user interface.

Example 41 includes the method of example 39, further including determining the item has reached the final destination, and causing display of product information using the second user interface.

Example 42 includes the method of example 41, wherein the product information includes one or more of a description of the item, a name of a person who initiated the delivery, a reason for the delivery, a link to initiate a refund for a value of the item, an additional QR code, or information from a receipt.

Example 43 includes the method of example 33, wherein the transit information includes one or more of an address, a shipping label, or an additional QR code, and the method further includes determining a type of transit information to provide based on a delivery service selected to transport the item.

Example 44 includes the method of example 43, further including associating the QR code with a user-initiated action.

Example 45 includes the method of example 44, wherein the user-initiated action is a return of an item.

Example 46 includes the method of example 44, wherein the user-initiated action is a shipment of an item.

Example 47 includes the method of example 44, wherein the QR code is associated with transit information.

Example 48 includes the method of example 44, wherein the method further includes facilitating execution of the user-initiated action.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine-readable storage medium comprising instructions to cause programmable circuitry to at least:
access a request based on a scan of a Quick Response (QR) code, the request including an identifier of the QR code;
determine whether the identifier is associated with an item for delivery;
after a determination that the identifier is not associated with the item, cause display of a first user interface for association of the identifier with the item; and
after a determination that the identifier is associated with the item, cause display of a second user interface to present transit information corresponding to the item.

2. The non-transitory machine-readable storage medium of claim 1, wherein the QR code is printed on a transit package.

3. The non-transitory machine-readable storage medium of claim 2, wherein the transit package is separate from a previous package in which the item was shipped.

4. The non-transitory machine-readable storage medium of claim 2, wherein the transit package is a polybag.

5. The non-transitory machine-readable storage medium of claim 1, wherein the QR code is printed on a sticker that is to be affixed onto a transit package, a user to place the item in the transit package for delivery.

6. The non-transitory machine-readable storage medium of claim 1, wherein the QR code is printed on a sticker that is to be affixed directly onto the item.

7. The non-transitory machine-readable storage medium of claim 1, wherein the instructions cause the programmable circuitry to:
determine a transit plan for the item; and
cause display of the second user interface to provide the transit information based on a status of the delivery relative to the transit plan.

8. The non-transitory machine-readable storage medium of claim 7, wherein:
the transit plan includes an intermediate destination between an initial location of the item and a final destination; and
the instructions cause the programmable circuitry to, in response to a change in the status of the delivery, cause display of the intermediate destination on the second user interface.

9. The non-transitory machine-readable storage medium of claim 7, wherein the instructions cause the programmable circuitry to:
determine the item has reached the final destination; and
cause display of product information using the second user interface.

10. The non-transitory machine-readable storage medium of claim 9, wherein the product information includes one or more of:
a description of the item;
a name of a person who initiated the delivery;
a reason for the delivery;
a link to initiate a refund for a value of the item;
an additional QR code; or
information from a receipt.

11. The non-transitory machine-readable storage medium of claim 1, wherein:
the transit information includes one or more of:
an address;
a shipping label; or
an additional QR code; and
the instructions cause the programmable circuitry to determine a type of transit information to provide based on a delivery service selected to transport the item.

12. The non-transitory machine-readable storage medium of claim 1, wherein the instructions cause the programmable circuitry to associate the QR code with a user-initiated action.

13. The non-transitory machine-readable storage medium of claim 12, wherein the user-initiated action is a return of an item.

14. The non-transitory machine-readable storage medium of claim 12, wherein the user-initiated action is a shipment of an item.

15. The non-transitory machine-readable storage medium of claim 12, wherein the QR code is associated with transit information.

16. The non-transitory machine-readable storage medium of claim 12, wherein the programmable circuitry is to facilitate execution of the user-initiated action.

17. An apparatus to facilitate item delivery, the apparatus comprising:
interface circuitry;
machine readable instructions; and
programmable circuitry to at least one of instantiate or execute the machine readable instructions to:
access a request based on a scan of a Quick Response (QR) code, the request including an identifier of the QR code;
determine whether the identifier is associated with an item for delivery;
after a determination that the identifier is not associated with the item, cause display of a first user interface for association of the identifier the item; and
after a determination that the identifier is associated with the item, cause display of a second user interface to present transit information corresponding to the item.

18. The apparatus of claim 17, wherein the programmable circuitry is to:
determine a transit plan for the item; and
cause display of the second user interface to provide the transit information based on a status of the delivery relative to the transit plan.

19. A method to facilitate item delivery, the method comprising:
accessing a request based on a scan of a Quick Response (QR) code, the request including an identifier of the QR code;
determining whether the identifier is associated with an item for delivery;
after a determination that the identifier is not associated with the item, causing display of a first user interface for association of the identifier with the item; and
after a determination that the identifier is associated with the item, cause display of a second user interface to present transit information corresponding to the item.

20. The method of claim 19, further including:
determine a transit plan for the item; and
causing display of the second user interface to provide the transit information based on a status of the delivery relative to the transit plan.
